(19) United States
(12) Patent Application Publication
(10) Pub. No.: US 2022/0215317 A1
(43) Pub. Date: Jul. 7, 2022

(54) Methods and Apparatus for Talent Assessment

(71) Applicant: Institute for Supply Management, Inc., Tempe, AZ (US)

(72) Inventors: Susan K. Marty, Sottsdale, AZ (US); Jessica A. Boyd, Gilbert, AZ (US)

(21) Appl. No.: 17/576,667

(22) Filed: Jan. 14, 2022

Related U.S. Application Data
(63) Continuation-in-part of application No. 17/224,954, filed on Apr. 7, 2021.
(60) Provisional application No. 63/006,219, filed on Apr. 7, 2020.

(51) Int. Cl. G06Q 10/06

(52) U.S. Cl. CPC G06Q 10/06393; G06Q 10/063112

(57) ABSTRACT

Methods and apparatus for talent assessment according to various aspects of the present technology may operate in conjunction with hardware and software to provide a talent assessment system, such as a talent assessment system accessible to a remote user comprising a database and a server. The server may provide a talent assessment to the remote user and stores results of the talent assessment in the database. The server may compare the results to target values and recommend an action for the organization according to differences between the results and the target values.

### CROSS-REFERENCE TO RELATED APPLICATIONS

This application is a continuation-in-part of U.S. patent application Ser. No. 17/224,954, filed Apr. 7, 2021, which claims the benefit of U.S. Provisional Patent Application No. 63/006,219, filed Apr. 7, 2020, and incorporates the disclosure of that application by reference.

### BACKGROUND

Workforce skills and competencies rank among an organization's greatest assets. Skills and competencies affect earnings, increase productivity, and enhance well-being. Investments in education and training, however, do not necessarily create workforce skills due to wide variations in quality and learning and rapidly changing skills and competencies.

Assessing skills can determine whether personnel perform according to standards, may benefit from further training, or exhibit skills that could be valuable in other roles, such as leadership or managerial roles. Workplace assessments can determine whether personnel perform the right jobs, increase employee satisfaction, improve employee and productivity, align training with company goals, and improve dynamic succession planning.

Optimal assessments investigate both technical skills and soft skills. Technical skills relate to specific tasks like computer programming, problem solving, operating equipment, and research. Soft skills, on the other hand, relate to communicating, critical thinking, work ethic, learning, relationships, and persistence.

Workplace skills assessment, however, involves observing personnel over time and using many methods to develop an overall assessment of a person's abilities and potential. Assessments are often conducted in person by an assessor, which requires time and expense to observe personnel, execute simulations, conduct interviews, and prepare tests. These assessment techniques suffer disadvantages because the personnel know that they are being observed and assessed, which can intimidate, distract, and otherwise affect behavior; the results may be affected by the communication skills of the assessor and personnel; and some perform better than others in any test environment.

For example, of the range of technical and soft skill competencies necessary to excel within the evolving field of supply management, nothing holistically addresses this gap in the market. Certain human resources technologies may offer different kinds of recruiting tests, including personality assessments and knowledge-based tests. But such technologies offer limited functionality and results.

Soft skills are a particular pain point for supply management leaders. Technical skills can be taught in training or on-the-job, yet strategic soft skills represent an untapped issue prevalent in today's corporate environment, both in mature and immature supply chain organizations.

Workplace skills assessments also focus on the individual personnel, not the overall organization. The organization relies on the skills of its workforce, but composing an accurate assessment of the entire workforce may be elusive. And without standards or goals for workforce competence, any full workforce assessment fails to meet its potential.

### SUMMARY

Methods and apparatus for talent assessment according to various aspects of the present technology may operate in conjunction with hardware and software to provide a talent assessment system, such as a talent assessment system accessible to remote users associated with an organization comprising a database and a server. The server may provide a talent assessment to the remote users and store results of the talent assessment in the database. The server may compare the results to target values for the organization and recommend action according to differences between the results and the target values.

### BRIEF DESCRIPTION OF THE DRAWING FIGURES

A more complete understanding of the present technology may be derived by referring to the detailed description and claims when considered in connection with the following illustrative figures. In the following figures, like reference numbers refer to similar elements and steps throughout the figures.

FIG. 1 is a block diagram of an assessment system according to various aspects of the present technology.

FIG. 2 is a block diagram of a server and database.

FIG. 3 is a block diagram including a server.

FIG. 4 is a block diagram of a system administrator module.

FIG. 5 is a block diagram of a client administrator module.

FIGS. 6A-I are representations of client administrator interface displays.

FIGS. 7A-J are representations of client administrator interface displays.

FIGS. 8A-E are representations of assessment displays.

FIG. 9 is a block diagram of a client manager module.

FIGS. 10A-D are representations of manager dashboard displays.

FIG. 11 is a block diagram of a client employee module.

FIG. 12 is a block diagram of an individual customer module.

FIGS. 13 and 14 are representations of results displays.

FIG. 15 is a flow diagram of an assessment system operation.

FIG. 16 is a block diagram of a setup system interacting with modules;

FIG. 17 is a flow diagram of a setup system.

FIG. 18 is a flow diagram of an assessment module.

FIG. 19 is a flow diagram of a reporting system.

FIGS. 20A-N are representations of system administrator dashboard displays.

Elements and steps in the figures are illustrated for simplicity and clarity and have not necessarily been rendered according to any particular sequence. For example, steps that may be performed concurrently or in different order are illustrated in the figures to help to improve understanding of embodiments of the present technology.

### DETAILED DESCRIPTION OF EXEMPLARY EMBODIMENTS

Various aspects of the present technology may be described in terms of functional block components and various processing steps. Such functional blocks may be realized by any number of hardware or software components configured to perform the specified functions and achieve the various results. For example, exemplary embodiments of the present technology may employ various servers, networks, storage systems, communications systems, algorithms, machine learning, software modules, remote access devices, user interfaces, processes, and the like, which may carry out a variety of functions. In addition, various aspects of the present technology may be practiced in conjunction with any number of fields of interest, and the systems and methods described are merely exemplary applications for the technology.

Various representative implementations of the present technology may be applied to any system for assessing talent or other characteristics of personnel and organizations. Methods and apparatus for assessing talent may operate in conjunction with a computer system, such as a local computer, a local area network, and/or a remotely accessible computer system connected to a communications network. The assessment system may implement an assessment model, such as to assess technical, functional, business, and soft skill competencies or personnel, teams, organizations, and other groups. The assessment system may include automated processes, such as for reporting results and analyses, organization benchmarking of assessment results, and manager review and assessment to provide a multi-degree perspective.

In an exemplary application, the methods and apparatus according to various aspects of the present technology are implemented in the field of supply management, which may include supply chain and procurement. The role of supply management within organizations has evolved rapidly in recent decades, and practitioners need to be increasingly strategic. While historically a function that focused on purchasing, supply management now encompasses broader supply management disciplines that are critical to business success. Procurement is a value-driver for organizations. The present technology may facilitate supply chain organizations, teams, and individuals taking a skill-based self-assessment and/or multi-degree assessment and benchmarking technical, business, and soft skills.

An assessment system according to various aspects of the present technology may be configured to support the supply management environment, including the procurement and supply chain environments. For example, the system may be adapted to include professional standards based on prevalence data and assessments, which may be applicable to related fields. The assessment system may be effective in the talent space, such as to craft a hiring assessment tool and related offerings for supply management (and other industry and profession) leaders to build and train high-performing teams in an informed, data-driven way. Individual and organizational data may ensure companies can create a clear path forward for their teams and respective areas of expertise (supply management, human resources, etc.).

For example, leaders of corporations with moderately mature organizations may utilize the assessment system, but the assessment system may serve smaller-to-mid-size organizations as well, or even individual users. Various embodiments may be adapted to other disciplines and expertise within the profession, and across industry sectors.

Other areas may also benefit from the assessment system's data. For example, human resources, talent management, recruiting, and chief human resources officers may leverage the data for hiring decisions and assessments. The assessment system may find application in many other areas (sales, marketing, product, etc.).

The assessment system may include elements such as platform structure, assessment capabilities, data uses, benchmarking, machine learning, job matching, development plans, and reporting, as well as the contents of the assessments themselves. Various embodiments relate to an assessment system including a software platform for talent assessments. The software platform may host a suite of data, benchmarking, assessment models, machine learning, and automation elements. The software platform may include capabilities for pop-up reminders, status updates, a dashboard with an overview of assessment status for a team, and profile administrative information. The assessment system, including the structure of the software platform, may be adapted to any suitable data, product design, application, and capabilities requirements.

The software platform may similarly support other professions' assessments that assess competencies, inclusive of skills, knowledge, and mindset applicable to a profession or trade. Various levels of prevalence data and benchmarking may be generated over time. Data can be cut or otherwise processed or analyzed across organizations, within industry verticals, and the like, to support talent management decision-making, and in other areas such as human resources and talent identification and development.

In one embodiment, the assessment system may be integrated into a dedicated software platform, with a featured algorithm and machine learning. Features can be set to turn on and off, for example based on purchases, licenses, and/or subscriptions. For example, participant entities may purchase access or licenses on a per assessment basis, such that the participant entity pays for access to a single assessment for an individual or multiple individuals. The software platform may feature elements such as the platform structure, assessment capabilities, data uses, benchmarking, machine learning, job matching, development plans and reporting, as well as the contents of the skills-based assessments, including survey content. In one embodiment, the assessment system analyzes future skill requirements, job roles, job descriptions, and competencies to surface trends using learned behavior. Participant entities can add additional and/or future skills or competencies to the assessment in technical and soft skill areas.

The software platform may offer talent assessment for a competitor's industry or area of practice for existing employees, new hire match capabilities, data from the assessment system and various ways to sort and review the data, and/or a database of professionals and/or contingent workers and the ability to match them with a job or generate a recommendation for the employer. In various embodiments, a database may store information regarding a large number of professionals and/or other workers in a single industry or across multiple industries, which may be used for a variety of purposes. For example, the database may include metadata tags corresponding to aspects of the workers, such as relating to specific job titles or roles and/or minimum skill levels in one or more competency areas. The tags may be used, such as using search tools, to identify personnel matching particular criteria, such as those of an open job posting. In various embodiments, machine learning systems may assist searches, such as to match competencies based upon individual responses and target values set.

The software platform may also provide a community of practitioners by profession and industry, with the unique data of their actual skills based on the assessment, as opposed to the individual practitioner self-selecting or otherwise assessing their own skills. The database of various professions, industries, competencies, roles, job descriptions and assessments, such as in one database, may facilitate the ability to leverage that data and report on it. The system may offer a complete database of all professions and the features described.

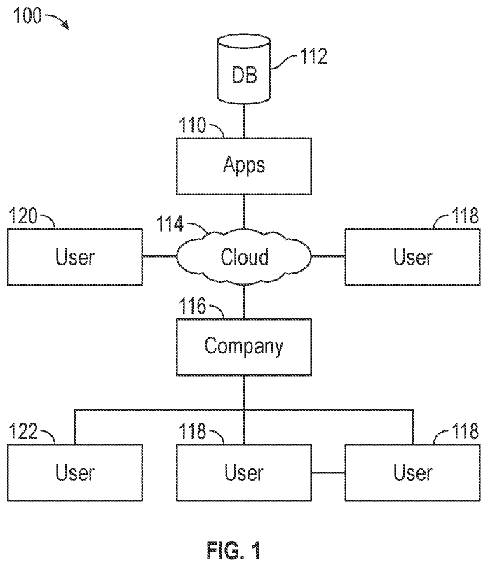

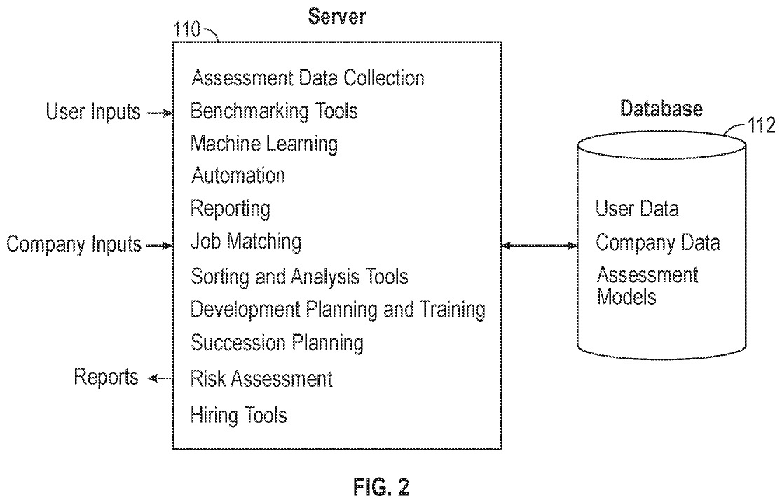

Referring now to FIGS. 1 and 2, an exemplary assessment system 100 for implementing methods and apparatus for assessing talent may operate in conjunction with a server 110 operating a software platform with access to one or more databases 112 and connected to a communications medium 114, such as the internet or other network. The server 110 may communicate with other computers and machines via the communications medium 114, such as company servers 116, employee work computers 118, remote personal computers 120, tablets, smartphones 122, and the like.

Generally, the company servers 116, employee work computers 118, remote personal computers 120, tablets, smartphones 122, and the like may communicate with the server 110 to assess talent and other professional characteristics among various users associated with a participant entity. The participant entity may be any appropriate entity, such as a company, a government agency, a university, a group of individuals, or an individual. In various embodiments, the participant entities are clients or customers of a business that operates the assessment system 100.

The other computers and machines may be used to communicate with the server 110 to utilize the assessment system 100, such as to respond to surveys, receive assessments and other output reports, perform administrative functions, and request data analysis and reports, and may utilize any appropriate communication methods and systems. In the present exemplary system, the other computers and machines may be used by participant entity leaders, administrators, employees, and other participants to access and interact with the server 110.

The other computers and machines may also be used by other parties, such as those requesting data and analyses and projections based on the data. In various embodiments, the computers and other machines do not require specialized software to interact with the server and may use conventional software, such as by communicating via an internet browser to interact with hardware and software of the server 110. In other embodiments, the computers and other machines may operate dedicated software to implement one or more aspects of the system and/or communicate with the server 110.

The communications medium 114 facilitates communication between various elements of the assessment system 100 and may comprise one or more media for electronic or other forms of communication. For example, the communications medium may comprise or utilize the internet, intranets, local area networks, cellular communications, and any other appropriate form of communication. In the present exemplary embodiment, the company servers 116, employee work computers 118, remote personal computers 120, tablets, smartphones 122, and the like may communicate with the server 110 via the Internet.

The databases 112 store information used and generated by the server 110, such as participant and other user data, company data and other participant entity data, and information used and stored by the assessment system 100. The databases 112 may also include external databases, such as commercial databases that provide data to third parties, databases owned or otherwise controlled by participant entities and/or other users of the assessment system 100, and/or publicly accessible databases.

The server 110 implements and/or coordinates the functions of the methods and apparatus for talent assessment. The server 110 may comprise any suitable system for implementing the functions, such as a computer system, multiple computer systems performing different functions of the overall assessment system 100, a distributed computing system operating on multiple machines, a virtual platform operating on one or more machines, a mainframe computing system, a cloud computing system, a computer cooperating with other computers to send and receive information, store and retrieve data, execute functions, render and receive services, and the like.

In the present exemplary embodiment, the server 110 may comprise a secure platform operating on one or more secure computer servers having access to the communications medium 114. The server 110 may be implemented and configured, however, according to any appropriate architecture and computing environment, including database architectures, data analytics capabilities, and communication/networking infrastructures. The server 110 may also operate in conjunction with and utilize other resources, such as web services and application programming interfaces.

In various embodiments, the assessment system 100 may provide a platform for assessing and improving talent, such as within an organization or for an individual. The platform may be implemented in hardware, software, firmware, or any combination, and may be implemented in conjunction with any appropriate equipment or systems. In the present exemplary embodiment, the assessment system 100 comprises a dedicated and secure software platform including an assessment module on the server 110 accessible to third parties, such as customers on a purchased, subscription, and/or licensed basis. The various capabilities and implementations of the assessment system 100 may be scaled and adapted for different disciplines, professions, industries, and environments.

The server 110 may also operate on data to generate output for the assessment system 100 according to one or more algorithms. The algorithms may provide any appropriate functions, such as to analyze future skill requirements, job roles, job descriptions, and competencies.

The server 110 may also implement other functions that may be appropriate for the assessment system 100. For example, in the present embodiment, the server 110 may include a calendar system for providing reminders, such as to take assessment surveys, subscription renewal, status updates, team reassessments, and the like. The server 110 may provide dashboards and pop-up reminders to users to provide any appropriate information, such as the status of an individual's assessments, team assessments, online communities, administrative information, and reminders.

An assessment system 100 according to various aspects of the present technology is accessible to multiple remote users associated with participant entity, such as an organization like a business. The database 112 may be responsive to the server 110, and the server may execute various functions of the assessment system 100. For example, the server 110 may provide talent assessments to the remote users, store results of the talent assessments in the database 112, and compare the results to target values, such as for the individuals and/or the organization. The server 110 may also recommend actions based on the results, such as an action to improve the organization and/or the individuals according to differences between the results and the target values and recommendations to advance the skills of individuals, teams, and other units within the organization.

In various embodiments, the server 110 provides a client administrator interface to a remote organization representative, and the client administrator interface requests information relating to the multiple remote users. The server 110 facilitates assigning a job role to each of the multiple remote users and selecting an assessment for each of the multiple remote users according to the assigned job role. The server 110 may provide a report to the organization relating to the comparison of the results to the target values selected for the organization, and provide an action recommendation for the organization based on the comparison of the results to the target values.

For example, the assessments may be provided to the users, and the results from the various users may be used to generate reports for the overall organizations, individual users, teams, or other units. The reports may be based upon comparisons of the results to target values for overall organizations, individual users, teams, or other units. For example, target values for an individual user may be selected according to one or more competency models for the user's job role(s), such that the target values reflect the expected performance of an individual in the job role. Different competency models for a particular job role might be available, such as for different levels of experience or organizational need.

In addition, the target values for an organization or other unit may be selected according to one or more competency models and/or maturity models, such that the target values reflect the desired profile of competencies for personnel in the organization. Competency models for an organization or other group of users may reflect the competency types and levels needed by an organization, such as according to the field of business for the organization. Maturity models may reflect the competency types and levels expected or desired by an organization, collectively or individually, such as according to development state of the organization or the experience of the individual. For example, a startup company may expect or accept lower levels of competency for certain disciplines, such as distribution skills, where an established company may expect much more mature levels of competency in such areas of professional practice. Likewise, a professional novice would be expected to exhibit lower competency levels in various competencies than an experienced expert.

The assessment system 100 may utilize the comparison of the results to the target values for the organization and the individual users to identify gaps between actual competency and desired competencies and recommend action. For individuals, the assessment system 100 may recommend types of training, mentoring, experience, and/or other advancement recommendations. For organizations and other units, the assessment system 100 may generate an organizational roadmap for achieving the desired target values for the organization and/or a talent roadmap for achieving the desired target values for the personnel, such as training, hiring, mentoring, consulting, and/or other measures.

In the present exemplary embodiment, methods and apparatus for assessing talent implemented in conjunction with the server 110 may comprise an assessment, software, and product suite. The assessment system 100 may facilitate setting up accounts, such as for individuals, teams, and companies to assess the talent of individuals, teams, and participant entities. The assessment system 100 may utilize target values for the organization, teams, individuals, and other entities, such as according to default target values, benchmarks, industry standards, and/or manually defined target values. The assessment system 100 may provide assessment reports using comparative data, such as benchmarking and/or prevalence data. In various embodiments, the assessment system 100 may generate and accumulate benchmarking and/or prevalence data. The assessment system 100 may track data indicating trends for personnel, such as trends in skills and/or development associated with roles, titles, competencies, and sub-competencies by profession, company, and other categories. By assessing the talent of personnel, potentially repeatedly over time, the assessment system 100 may identify underutilized talents and other resources and associated value, rank skills for a team, and assess the impact of new team members.

The assessment system 100 may further provide guidance for future planning and improvement. For example, the assessment system 100 may identify new competencies, titles, and roles for future needs based on data collected and analyzed by the assessment system 100, as well as create and inform future job descriptions, such as to fill an identified need in an organization. For example, the assessment system 100 may provide participating entities with a proposal function, which allows participating entities to propose new competencies, titles, and roles to be assessed and/or tracked based on their needs. In one embodiment, the participating entity can provide information relating to the new subject for assessment, such as a brief description and title of a new skill or competency. The assessment system 100 may monitor the proposals across multiple organizations and implement new assessments and/or tracking and data analysis according to the proposals, such as in response to a threshold number of proposals for similar new subjects. New subjects may be added manually, such as by the system administrator in response to proposals, or automatically, such as by an artificial intelligence (AI) system in response to proposals for similar subjects.

In addition, the system administrator and/or the AI system may identify gaps in demand in the market for specific skills for current and/or future needs. For example, the AI system may monitor the addition of competencies, titles, and roles on an ongoing basis, and identify the frequency and total number of entries of similar information to make recommendations for periodic updates and additions.

Talent assessments by the assessment system 100 may inform training decisions and development plans for an individual, team, and/or company by identifying gaps in training, and may also serve as a hiring tool to evaluate candidates. The talent assessments may facilitate and inform soft skills training, covering topics such as negotiation, stakeholder engagement, leading change, and structured communications. Additional assessments and reassessments over time may facilitate data comparisons and planning, including company and individual development and movement.

These and other development investment recommendations may be provided by the assessment system, including in conjunction with machine learning. For example, as the assessment system 100 may implement a machine learning system to analyze the skills and other data for a participating entity and predict and recommend training, education, and development based on identified competency gaps, standard target values, and/or objectives identified by the participating entity. The machine learning system may compare data at the company and individual levels, which can lead to increased validity and value in the recommendations provided to participating entities.

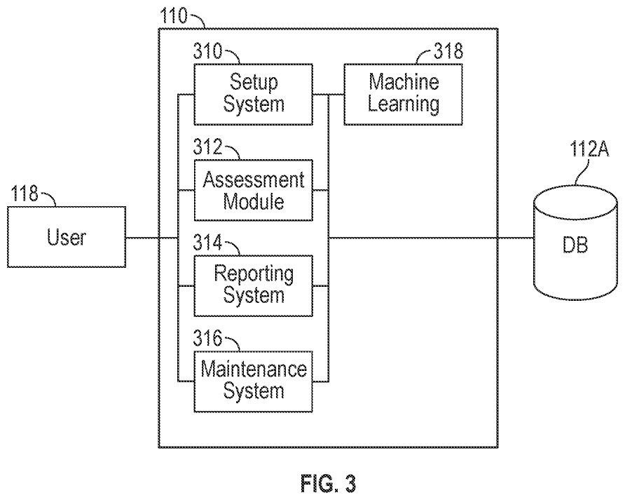

Referring to FIG. 3, in various embodiments, the server 110 may provide a setup system 310 for starting a talent assessment, an assessment module 312 for gathering assessment data from users, a reporting system 314 for providing reports based on gathered and analyzed data, and a maintenance system 316 for scheduling follow-up assessments and updating data and improvement strategies.

The setup system 310 facilitates gathering and storing information to begin assessments, such as names, contact information, positions, company structure and background, and the like. The setup system 310 may gather any suitable information and store the data in any appropriate format. For example, the setup system 310 may provide a system administrator setup module for the system administrator and a client administrator setup module for the participant entity. Each setup module may gather information from the relevant user to set up the assessment for the participant entity and may facilitate cooperation and consultation between the system administrator and client administrator.

The assessment module 312 gathers assessment data from users, such as employees and other individuals. The assessment module 312 may gather assessment data in any appropriate manner, such as by providing questions, situations, images, hypotheticals, and other material to generate a response from the user. The assessment module 312 may receive and store the responsive data received from the users, as well as other information like the user's account information, speed of responses, security information, time and date on which responses were submitted, and any other relevant data.

In various embodiments, the assessment module 312 may provide surveys to users comprising multiple questions according to parameters received from the setup system 310. The surveys may include various question types, including abstract reasoning, right/wrong answers, multiple choice, scenarios, situational analysis, and simulations. The platform may identify patterns for all question types, and assessments may be performed under a set time limit. The users provide responses to the questions, and the assessment module 312 receives and stores the responses, for example in a secure database 112A.

The assessment module 312 may present questions or content in any appropriate format and according to any appropriate criteria. For example, the assessment module 312 may present conventional testing or survey content, such as to identify skills and abilities of individuals at a particular time. In various embodiments, the assessment module may present surveys including standardized questions on one or more topics, and may include demographic questions of respondents.

In various embodiments, the assessment module 312 may present content that is unique to the participant entity, such as survey content relating to a particular organization's products, services, procedures, and/or personnel. The assessment module 312 may present content to identify skill gaps (i.e., differences between a target value and an actual current level) in areas of individual and organizational skill. For example, the assessments provided by the assessment module 312 may be profession-specific and/or soft-skill based assessments to evaluate competencies. While the type of formats for questions asked (multiple choice, right/wrong, etc.) may be similar to conventional surveys, the insights derived from how the assessment content is created can be used by the participant entity for multiple purposes, such as identifying human resources requirements, providing additional training, and assessing performance.

Further, each assessment provided by the assessment module 312 may be supported by an accompanying competency model including definitions at the competency and subcompetency levels for each KSA (knowledge, skills and/or ability) at different levels of performance. The competency model may comprise one or more competencies associated with effective job performance in a field, discipline, profession, and/or job role. Competency models may include detailed information, such as key behaviors and standards of proficiency that apply to different levels of job experience or expertise. In various embodiments, each assessment in the system may be created according to a corresponding competency model, and each job role in the system may be associated with a competency model.

The assessment module 312 may provide assessments focused on the individual learner or multiple individuals together, like a class, team, institution, participant entity, or specific program. The assessment module 312 may request information to produce an overview of a participant entity's capabilities, such as prior to instruction on a given topic. This provides not only baseline performance information, but also provides the opportunity to customize instruction and provide individual learning plans. Summative, or post-instruction assessment may provide incremental data relevant to the success of a training program.

The assessment module 312 may generate information to support the further development of the participant entity. For example, the assessment module 312 may provide an assessment, and following completion, the assessment system 100 may automatically provide training and development opportunities or recommendations for training and development to the participant entities to improve performance in areas of interest. By facilitating targeted training and development, the assessment system may build a longer-term development plan at the organizational level and/or the individual level. By conducting multiple assessment of the same participant entities, the assessment system 100 may operate effectively as a formative and/or summative assessment tool.

The reporting system 314 provides reports based on the received responsive data, such as from the assessment module 312. In the present embodiment, the reporting system 314 receives the responsive data from the assessment module 312 and/or other sources and generates corresponding reports. The reports may comprise any suitable reports, such as graphical representations of the data, comparisons to historic data, target values, and/or benchmarks, prevalence data, summaries, conclusions, analyses, and proposed action plans at the individual, team, and/or organizational levels.

The maintenance system 316 may facilitate action plans and future assessments, such as using scheduling and improvement strategies. For example, the maintenance system 316 may schedule dates for taking action in conjunction with an action plan generated by the reporting system 314. The maintenance system 316 may also schedule follow-up assessments, for example to track improvements in various fields such as relevant competencies.

In various embodiments, the server 110 may include a machine learning system 318 or other artificial intelligence and/or data mining system. For example, the machine learning system 318 may include a supervised learning system, an unsupervised learning system, a reinforcement learning system, or other system that causes a computer to act without being explicitly programmed. In the present system, the machine learning system 318 may perform multiple functions, such as capturing and creating learned benchmarks for various competencies, sub-competencies, roles, and titles, matching job titles and descriptions to job roles, identifying relevant skills and competencies for various job roles and adjusting assessments associated with the job roles and identifying customer needs and preferences for results reporting. The machine learning system 318 may also analyze and identify future skill requirements, job roles, job descriptions, and competencies, such as to surface trends using learned behavior.

For example, the machine learning system 318 may capture and create learned benchmarks according to the frequency and number of requests for new or future-focused competencies that are not currently within a given assessment. Likewise, the machine learning system 318 may capture and create new roles and titles according to the frequency and number of requests for new roles and titles that are not currently used by the assessment system 100. In various embodiments, the machine learning system 318 may learn and adjust benchmarks automatically as needed with each additional set of results captured. The machine learning system 318 may update learned benchmarks according to a threshold, such as the upper quartile of actual results on an ongoing basis. The system administrator may also set initial benchmarks and manually update the benchmarks. Benchmarks may be applied for different competencies, roles, titles, professions, reports, and the like, such that the machine learning system 318 may accommodate evolving professions, organizational structures, and competencies. For example, in supply management, if more demand emerges for data-related roles and competencies, an indicator and trend would emerge from the machine learning system 318 that this is a direction the profession is headed.

The scope and accuracy of the machine learning system 318 may improve as additional data is accumulated over time and may be implemented to accommodate additional and/or future skills or competencies, such as by additional technical and soft skill areas in talent assessments. Over time, the platform's machine learning may capture and create learned benchmarks for competencies, sub-competencies, job roles, and titles. This may include future roles and added competencies provided by any participant entities.

The server 110 may implement various functions to achieve the various features and results of the assessment system 100. The functions may be implemented in any suitable manner, such as in conjunction with multiple software modules and interfaces available to different types of users. The assessment system 100 may permit different users to interact with different functions and privileges, for example according to the type and/or access level of the user. In various embodiments, the assessment system 100 may provide functional modules or other software and/or hardware systems to provide access to different users.

For example, in the present embodiment, the assessment system 100 implements dedicated user experiences for a system administrator, a customer administrator, a customer manager, and a customer employee. The assessment system 100 may also implement other appropriate user experiences, such as for an individual user not associated with or otherwise operating independently from a customer company. The various experiences and functions may be implemented by software and/or hardware generally described as modules for performing various functions, which may include program components that contain one or more routines. One or more modules may be part of a larger program. Each module may serve a unique and separate business function. The modules described may be implemented, however, in any appropriate manner to achieve the various functions.

The assessment system 100 may implement a system administrator module on the server 110 for controlling the overall operation of the assessment system 100. The system administrator module allows a system administrator to control the assessment system 100, such as by adding and removing participant entities, creating assessments and/or other products, creating surveys and content, administering assessments and surveys, setting up communications, and creating and controlling analytics.

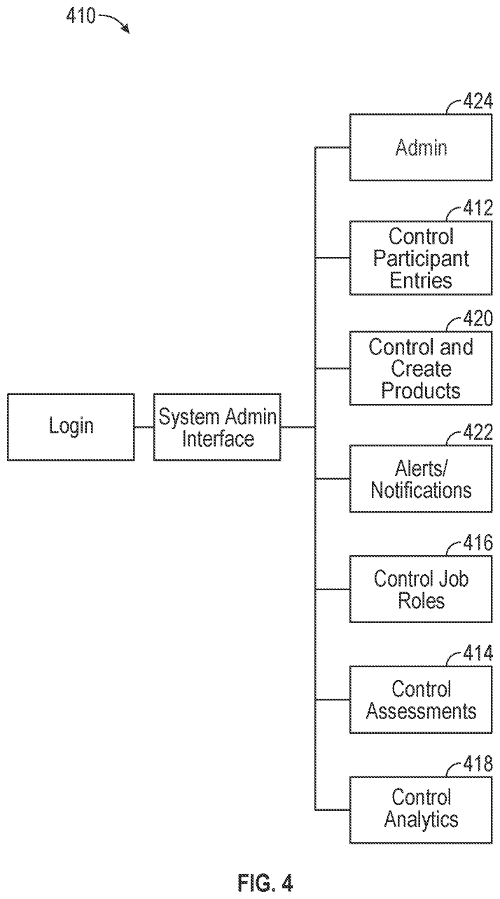

For example, referring to FIG. 4, an exemplary system administrator module 410 may facilitate controlling participant entity accounts 412, such as setting up a new client account for a new company, team, individual, or other participant entity. The system administrator module 410 may utilize any appropriate information for the account, such as the name of the client and the name and contact information for the client administrator. The system administrator module 410 may also utilize information relating to talent assessment projects, such as project timelines, reporting arrangements, and calendaring milestone client meetings.

In one exemplary embodiment, system administrator module 410 may initiate collection of various data from the participant entity, with asterisks (*) indicating inputs or fields that may be required.
Company Name*
Company Size
Industry*
Number of Employees to Assess*
Job Descriptions
Job Titles*
Job Roles*
Job Level
Company Functional Area or Team
Number of Employees in Functional Areas or Teams
Company Competency Target values* (custom available)
Use of Benchmark and Standards Target Values* (selection)
New Skills or Competencies Added/Adjusted with Description
New Sub-Competencies Added/Adjusted with Description
Future Competencies Added with Description
Future Sub-competencies Added with Description
Organizational Goals
Administrator or Leader Contact*
Reporting Manager
Employee Names*
Employee Emails*
Direct or Indirect
Manufacturing or Services Industry (mapped based on NAICS code)

The system administrator module 410 may contact the client administrator, such as via an email invitation, to open the client administrator setup module to provide information to support the talent assessment. The invitation may address any appropriate matters, such as providing internal communication suggestions and requesting new or future competencies, skills, and job roles from the participant entity.

In one embodiment, the system administrator module 410 provides a system administrator interface to the system administrator personnel for initiating and controlling various functions of the overall assessment system 100, such as creating surveys and other products 420 and job roles 416, setting up and controlling accounts for participating entities 412, creating and launching assessments 414, creating assessments and reports 414, and controlling analytics 418. The system administrator interface may be implemented in any appropriate manner to facilitate system administrator control of the various functions, such as a graphical user interface presenting multiple interactive options.

The system administrator interface may offer options, such as controlling products 420 offered on the assessment system 100, viewing and responding to alerts 422, creating and controlling job roles 416 utilized by the assessment system 100, monitoring and controlling assessments in progress or completed 414 by the assessment system 100, controlling analytics 418 for output reports, viewing notifications 422 regarding assessments and tasks, and administrative functions 424 like controlling the system administrator's account and team.

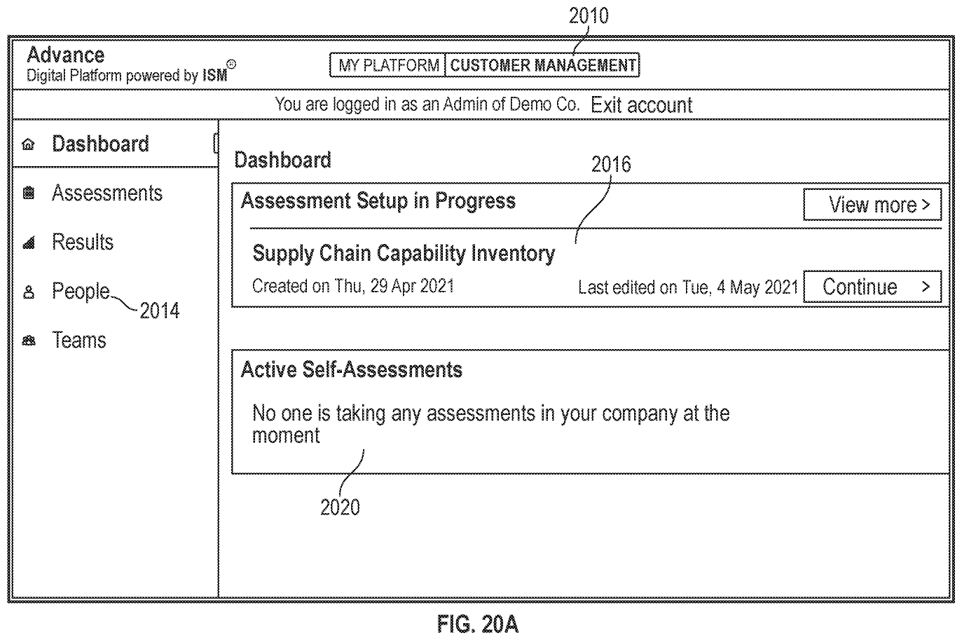

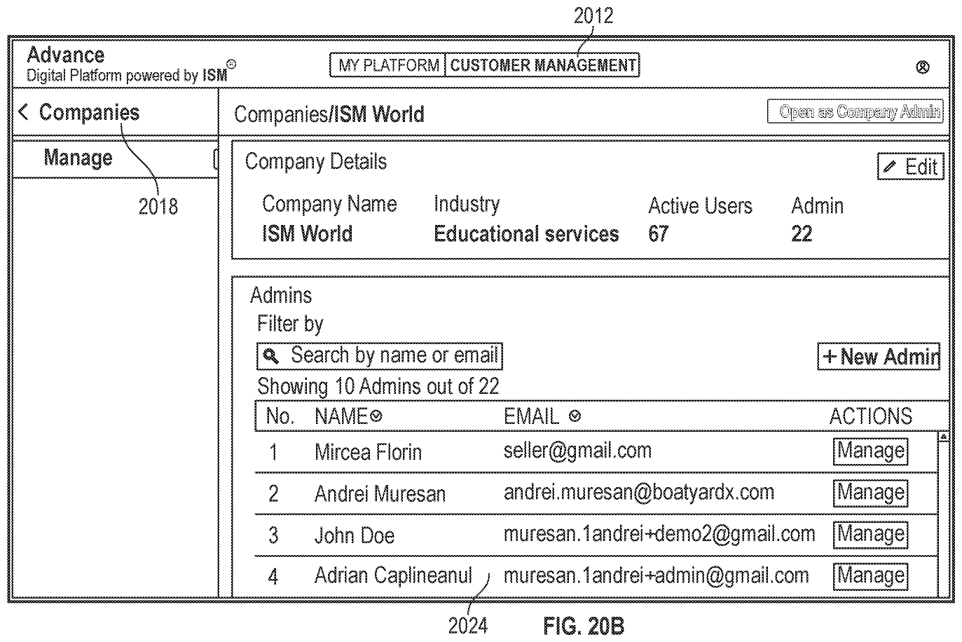

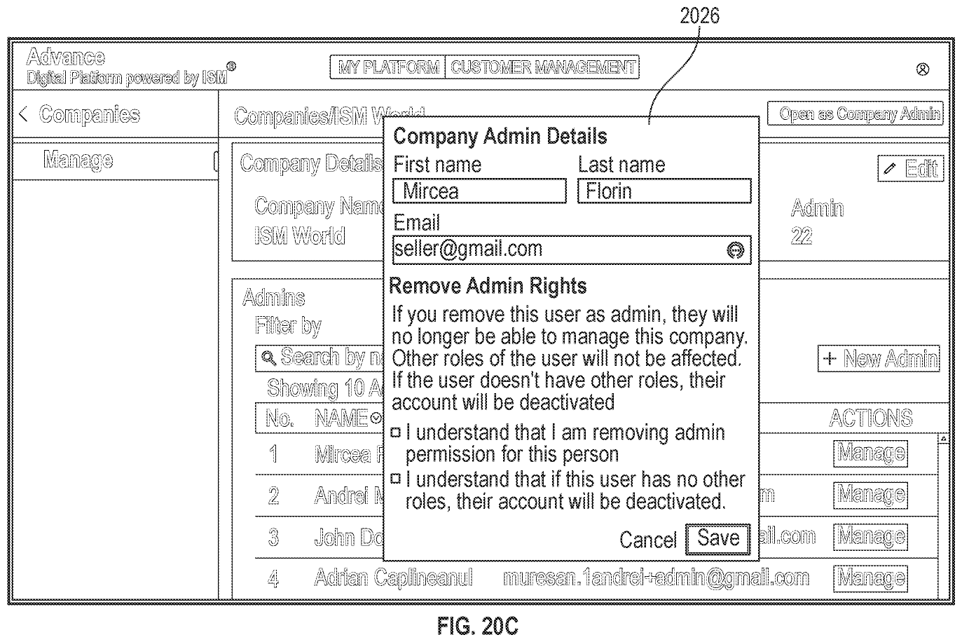

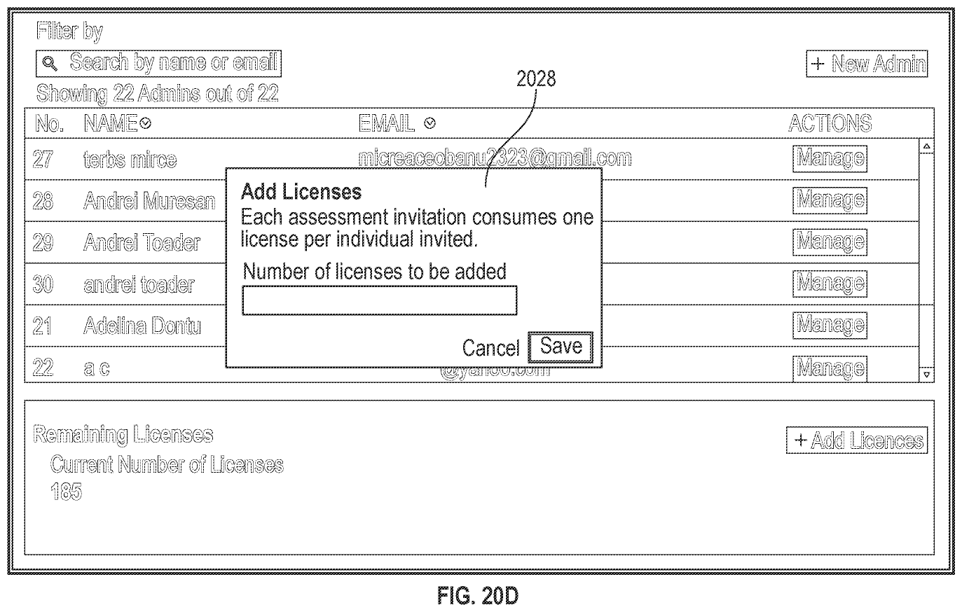

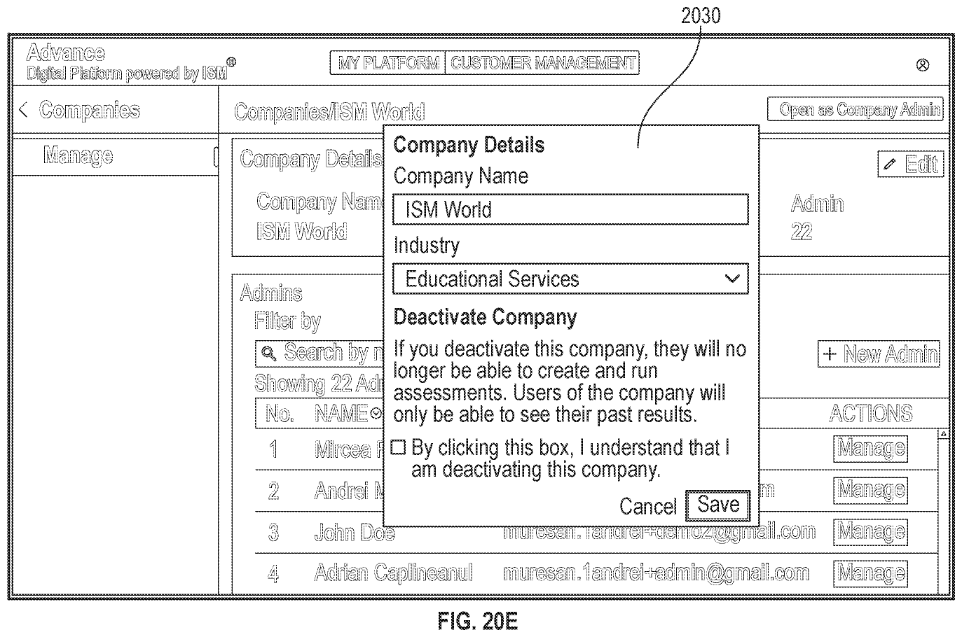

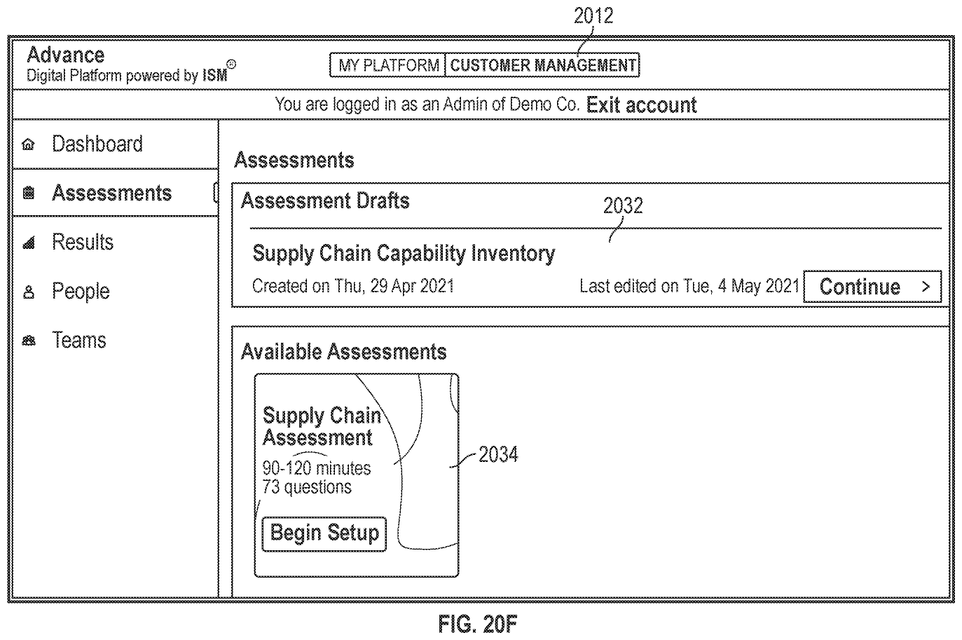

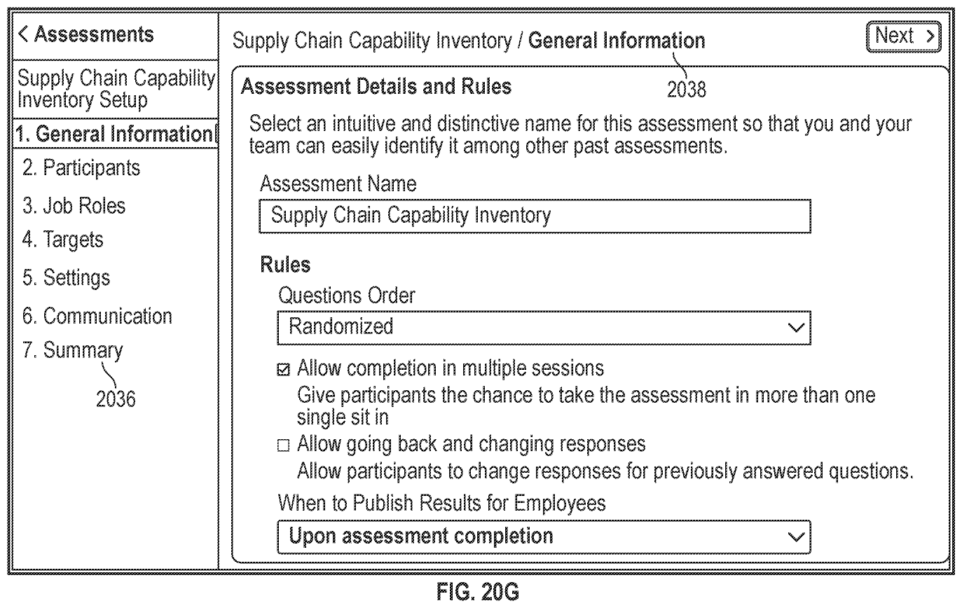

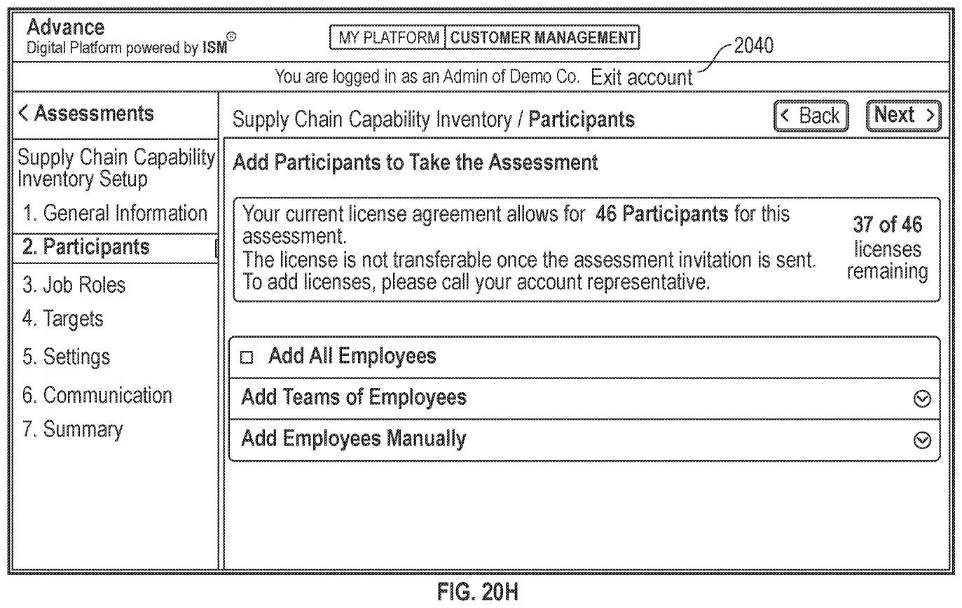

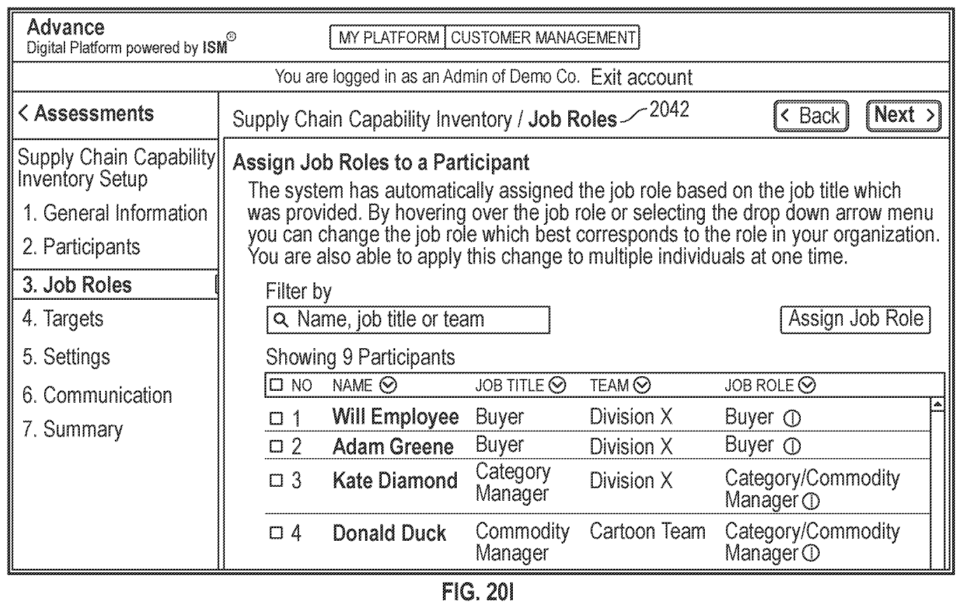

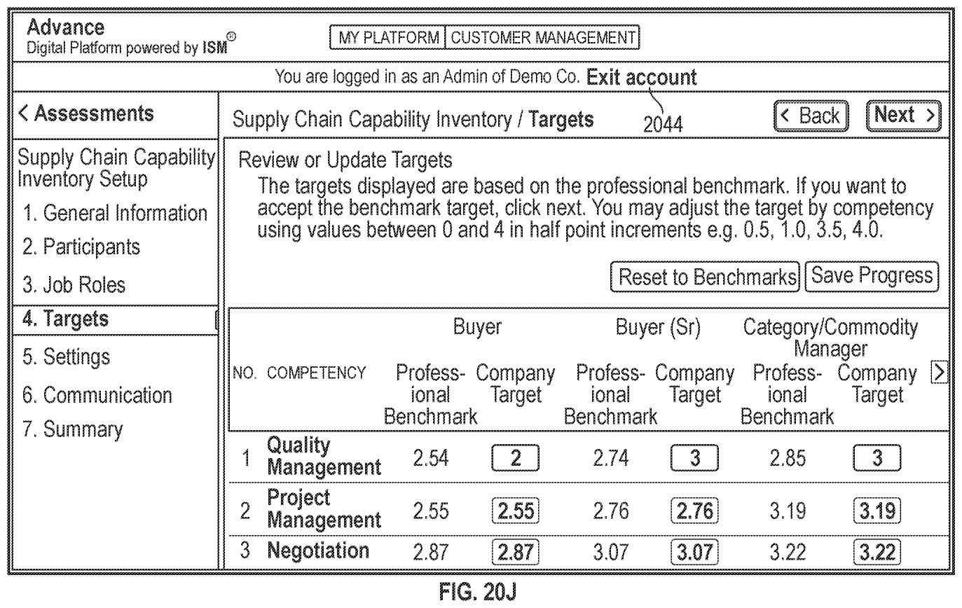

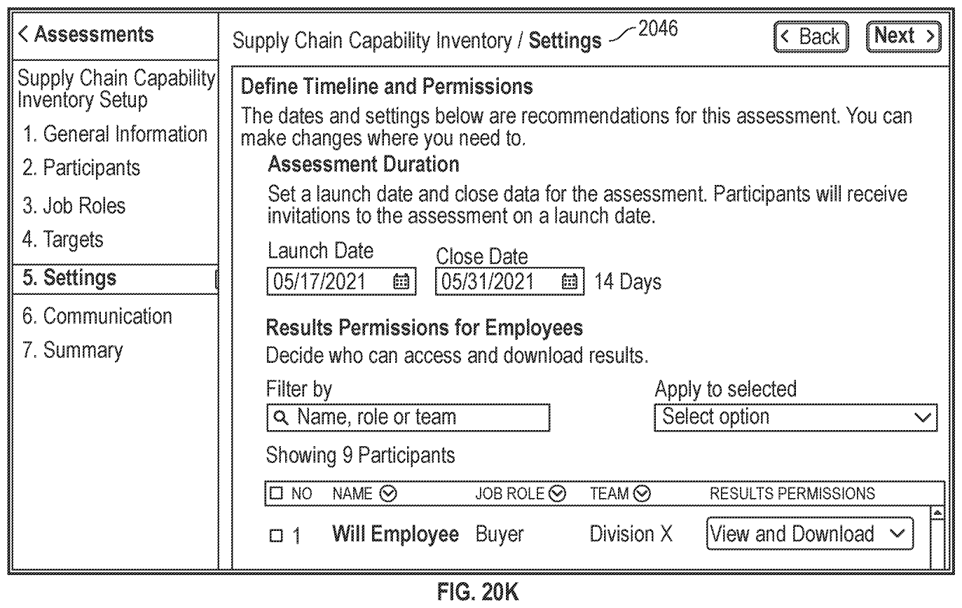

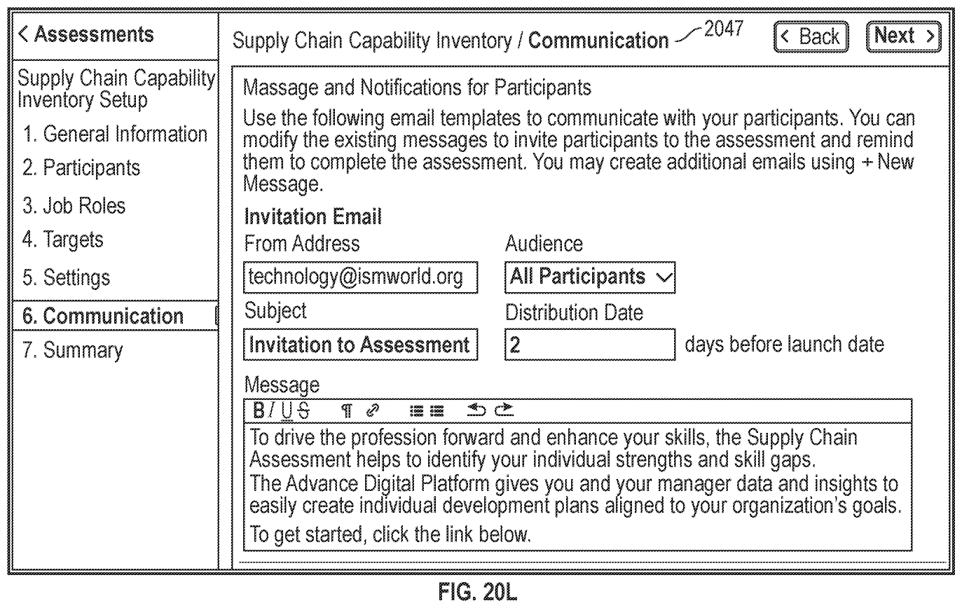

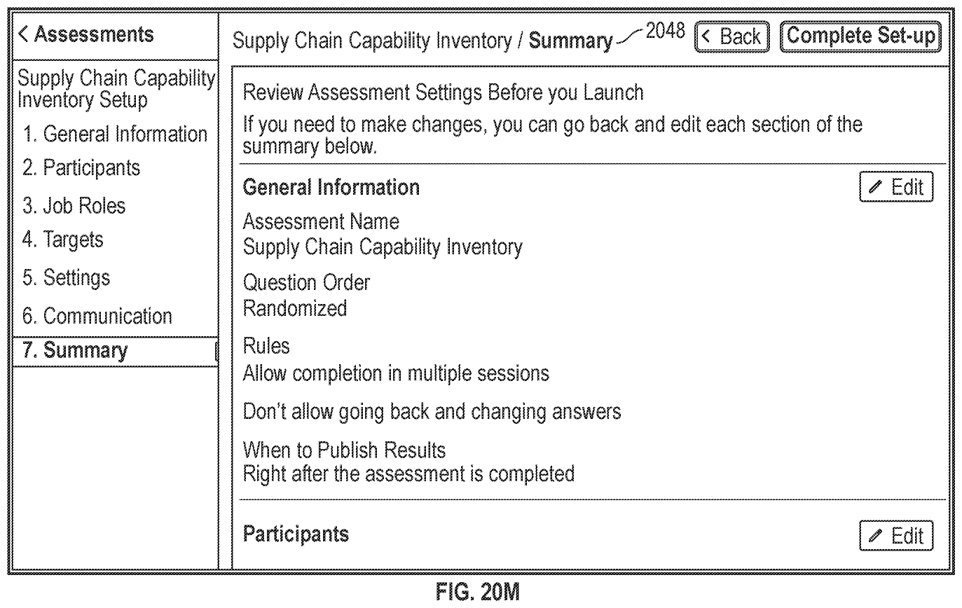

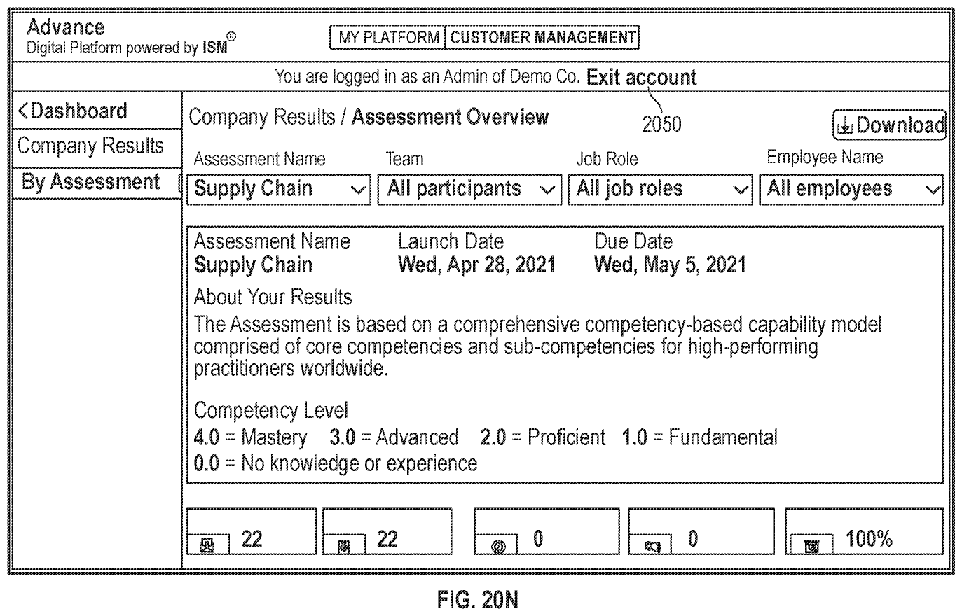

For example, referring to FIGS. 4 and 20A-N, the system administrator interface may comprise a system administrator dashboard 2010 with interactive selectable options to create and manage products 420 such as assessments, create and manage job roles 416, create and manage assessments 414 for participant entities, create and manage accounts for participant entities 412, create and control analytics 418, and perform various administrative functions 424. The system administrator interface may be implemented in any suitable manner, however, and may provide any appropriate functions for a particular application or environment.

In the present embodiment, the system administrator interface facilitates administrative functions 424 through various menu items, such as creating and managing user accounts, passwords, authorizations, and/or system settings, as well as similar functions for the system administrator's account and those of the system administrator's team. The system administrator interface may also provide alerts and notifications 422, such as automated alerts and notifications relating to requests for account removal and the status of assessments, for example, whether various assessments have been launched or completed and whether progress reports are due or have been prepared.

The system administrator interface may also facilitate managing the accounts of participant entities 412. For example, the system administrator interface may allow participant entities to be added, removed, viewed, searched, filtered, and sorted. The system administrator interface may automate sending invitations to members of participant entities, such as participant entity administrators, individual participants, and participant entity managers, for example to set up accounts, which users may be prompted to update after an invitation, and participate in assessments. The system administrator interface may also facilitate managing participant entity personnel, teams, assessments, permissions, and accounts.

The system administrator interface may also facilitate creation and management of job roles and groups 416. Job roles comprise generic descriptions corresponding to roles performed by personnel in various organizations under different titles and job descriptions. For example, the job role “buyer” may apply to any personnel whose job involves acquiring goods and/or services on behalf of the organization, although such personnel may have different job titles including references to purchasing, procurement, or sourcing within the supply management profession. The job roles may also be refined within a category, such as Buyer 1, Buyer 2, and Buyer 3 or Buyer, Senior Buyer, and Supervisory Buyer, reflecting different levels of experience and responsibility.

Job role groups are groups of related job roles and/or job titles. For example, the “buyer” group may include any related job role, including buyer/planner, procurement specialist, or purchasing agent. Individuals with seemingly disparate job titles may share job role group, such as when performance expectations, such as assessment target values, are similar or identical across the assessment criteria. Thus, different personnel with different titles but similar performance target values may be in the same job role group.

The assessment system 100 may automatically assign a job role to a participant based on any appropriate criteria, such as job title, responsibilities, and/or job description. For example, an exemplary assessment system 100 may assign the job role primarily according to the job title, but may adjust the job role according to any other suitable criteria. In various embodiments, the assessment system 100 may assign the job role based upon a table of titles mapped to a library of roles and corresponding targets. The machine learning system 318 may also automatically assign or suggest the job role based upon, for example, job title similarities and job description elements.

If the automatic assignment is unsuccessful or inaccurate, the job role may be selected manually, such as from a list of possible job roles and descriptions of those job roles. If a job role is inappropriate, the system administrator may override automatic classifications and assign another job role group. The system administrator interface may facilitate adding, removing, viewing, filtering, sorting, searching, and editing job roles and groups for the assessment system 100.

The system administrator interface may also facilitate creating, viewing, removing, and editing assessments 420, such as template assessments and custom assessments. Assessments comprise one or more surveys to be completed by personnel associated with participant entities or as individuals. The assessments may be created in any appropriate manner and according to any suitable criteria. In various embodiments, an assessment may be designed to assess the skills, talents, and development of an individual relevant to a job role. For example, a supply chain competencies assessment may be designed to evaluate an individual's skills in sales and operations planning, quality management, category management/commodity management, sourcing, and legal, among other relevant competencies. Such an assessment would include surveys designed to identify the participant's skills in each competency and/or various subcompetencies. Different job roles may be assigned to multiple assessments according to the skills and talents related to the job role.

Assessments may also assess soft skills, such as “people acumen” and other leadership competencies, which may generate richer content and data outcomes for the assessment system. Soft skills assessments and other assessments, such as technical, talent, individual, organizational maturity, etc. can be done along with the overall talent assessment or operated as a standalone assessment.

The system administrator interface may facilitate creating and editing template assessments, which may comprise general or default assessments designed for a particular job role. In many instances, the template assessments may be applicable for common job roles and may be used across most participant entities within a given profession, such as supply management. The system administrator interface, however, may facilitate creation of custom assessments to address the needs of specific participant entities or new job roles.

In the present embodiment, the system administrator interface provides a selection to create an assessment, including a name, description, and time to complete the assessment. The system administrator interface may create the assessment by mapping competencies to the job role automatically or manually, providing question content for the surveys in the assessment, answer types, scoring parameters, and identifying any other properties for an assessment. For example, the system administrator interface may facilitate creating assessments by dragging and dropping existing competencies from a library to create unique assessments. In one embodiment, the system administrator interface automatically maps competencies to job roles using stored information matching roles to competencies, which may be updated by the machine learning system 318.

The system administrator interface may facilitate monitoring assessments that are in progress or completed 414. For example, the system administrator interface may provide a list of in-progress assessments that have begun but are not yet completed. The list of assessments in progress may be filtered, sorted, and/or searched. The system administrator interface may likewise provide a list of completed assessments. The list of completed assessments may be filtered, sorted, and/or searched.

In the present embodiment, the system administrator interface may allow the system administrator to view assessment details according to any appropriate criteria, such as according to all participant entities, individual participant entities, teams, groups, and/or participant users. For completed assessments, the system administrator interface may provide an option to proceed to the next stage, such as generating insights and corresponding reports.

The system administrator interface may also facilitate generating reports 418 based on data in the databases 112. The reports may comprise any appropriate reports, such as reports for a particular participant entity, deportment, team, or individual, and may contain any relevant data, trends, amalgamations, or other information derived from the assessments and/or other resources. For example, the system administrator interface may generate reports according to assessments, competencies, subcompetencies, and job roles for participant entities, across industries, across geographies, or any other suitable or selected criteria. The system administrator interface may include functions for viewing, filtering, searching, sorting, and/or editing assessment data and information derived from assessment data, as well as for exporting the reports and analyzing the data.

For example, in one embodiment, the system administrator interface may facilitate accumulating prevalence data and creating benchmarks for various parameters, such as competencies and subcompetencies overall or within categories, such as within job roles and industries. Prevalence data corresponds to a person's likelihood of exhibiting a particular competency level, subcompetency level, or other characteristic. The benchmarks may comprise quantitative and/or qualitative data, such as measurements of performance indicators, and information derived from the data representing overall actual practices and performance among data sets, such as within organizations, industries, geographies, and/or job roles. The benchmarks may comprise any appropriate metrics, such as to reflect industry standards, compliance, and best practices.

The data gathered by the assessment system 100 may be used to generate benchmarks in any appropriate manner. For examples, the system administrator interface may facilitate defining the subject of the benchmark and/or the process or attribute to be studied. The system administrator interface may facilitate selecting and defining the measures to be used and the comparison set. The system administrator interface may also initiate generating benchmark reports, such as by comparing a participant entity's data to a comparison set and identifying differences and gaps. The report may also provide analyses of the root causes of the differences or gaps and proposed improvement initiatives including goals.

In the present embodiment, data acquired from participant entities and/or third parties may be leveraged for benchmarking and prevalence data across individual and organizational assessments, as well as surveys or assessments of practice areas. The assessment system 100 may build a pool of organization, industry, and team data, which may be used for various applications, such as benchmarking and prevalence data capabilities. Reporting at such levels can provide deeper content to enhance and inform other related product areas (education, certification, research, etc.).

In various embodiments, the assessment system 100 may employ machine learning 318 to capture and create learned benchmarks, such as for competencies, sub-competencies, roles, and titles. Benchmarks may be included for future roles and added competencies provided by any participating entities.

Reporting outputs may be provided to any appropriate personnel, such as company leaders, administrators, managers, and individuals, for example using contact information in accounts for users and other personnel. The reports and/or associated data may be stored, and specific sets or cuts of data may be provided and associated with authorized accounts, such as for the duration of subscriptions or otherwise. Historical data may be leveraged for benchmarking and prevalence data across individual and organizational assessments, as well as surveys or assessments of practice areas.

In the present embodiment, referring to FIG. 20A, the system administrator dashboard 2010 may offer options 2014 for controlling information and assessments relating to participant entities, such as options relating to assessments, results, people, and teams. The system administrator dashboard 2010 may provide an option for setting up assessments for participant entities 2016 and monitoring assessments in progress 2020. Referring to FIGS. 20B-E, the system administrator dashboard 2010 may offer an option for a participant entity management interface 2012 to manage participant entities, for example to review company administrators, add details for company administrators 2026, add licenses for a participant entity 2028, and add and edit details for participant entities 2030.

Referring to FIGS. 20F-N, the present system administrator dashboard 2010 also offers options for controlling assessments for a participant entity 2014, such as setting up assessments 2032 and selecting assessments 2034. Upon selecting an assessment, the system administrator dashboard 2010 may provide information and control functions 2036 for the assessment, such as general information 2038, reviewing and controlling participants in an assessment 2040, reviewing and controlling job roles associated with participants 2042, and providing and editing target values for an assessment 2044. The system administrator dashboard 2010 may also facilitate controlling settings 2046 like the start date and duration of an assessment and access privileges for various participants, communications with participants like reminder emails 2047, and reviewing and editing information for assessments 2048. Further, the system administrator dashboard 2010 may provide an overview of an assessment 2050, such as all of the parameters associated with an assessment.

The assessment system 100 may implement a client administrator module for controlling the participant entity's use of the assessment system 100. The client administrator module may allow a client administrator to control authorized elements of the assessment system 100, such as by adding and removing teams, managers, employees, and other users, selecting assessments and/or other products, monitoring assessments and surveys, and requesting and reviewing analytics and other reports.

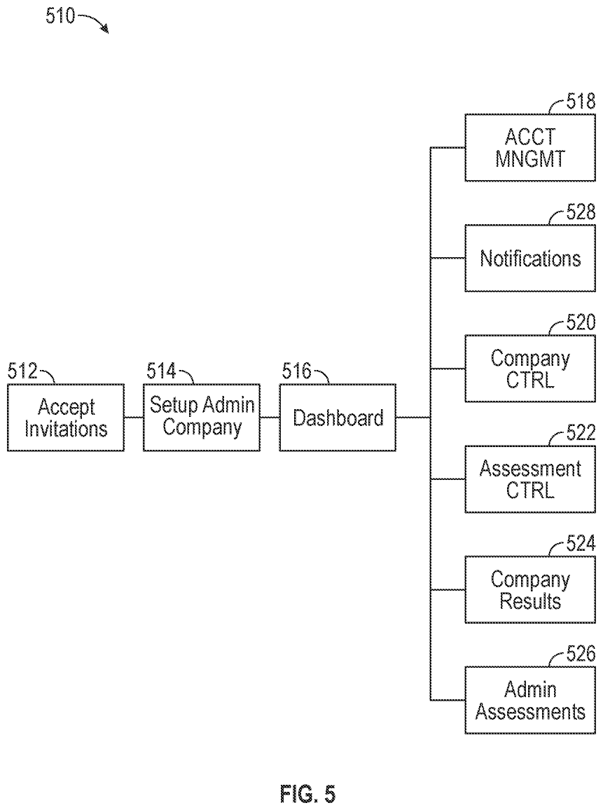

For example, referring to FIG. 5, an exemplary client administrator module 510 may set up account information for the participant entity and arrange assessments for the participant entity. In the present embodiment, the client administrator personnel may receive an invitation, such as an electronic communication with a link, to access the assessment system 100. When the client administrator accepts the invitation 512, the client administrator's computer or other device may contact the server 110 and access the client administrator module 510. In various embodiments, the client administrator module 510 may prompt the client administrator for information, such as participant entity data and identifying information for employees to be assessed 514. The client administrator module 510 may request any suitable information, such as:
Company Name
Company Size
Industry
Number of Employees to Assess
Job Descriptions for Employees to be Assessed
Job Titles for Employees to be Assessed
Role Levels for Employees to be Assessed
Company Functional Area
Number of Employees in Functional Areas
Company Competency Target Values or Goals
Custom or Standard Competency Target Values or Goals
New Skills or Competencies Added/Adjusted with Description
New Sub-Competencies Added/Adjusted with Description
Future Competencies Added with Description
Future Sub-competencies Added with Description
Organizational Goals
Administrator or Leader Contact
Reporting Manager
Employee Names
Employee Email Addresses
Job Level Ranking
Direct or Indirect

The client administrator module 510 may use information received from the client administrator to set up an account for the participant entity. The client administrator module 510 may take additional steps, such as mapping job descriptions to job roles and proposing a timeline for assessment completion and generating automated reminders.

In the present embodiment, the client administrator may select or develop a communications plan for communicating with the system administrator and client personnel, assess needs for talent development among client personnel, identify key personnel such as leaders, administrators, and team managers, and review assessment system 100 features and select options that best fit the participant entity's needs. The client administrator module 510 may generate an assessment plan including personnel to be assessed, the assessments to be taken by the various personnel, timelines for completion of the assessments, and desired output reports and analyses.

The client administrator module 510 may automatically invite personnel to set up accounts, including employees to be assessed, managers, and leaders. For those to be assessed, the users may provide additional personal and professional information, and may select assessment types, job roles, target values, and skills to be developed. Additionally, or alternatively, the client administrator module 510 may provide some of the information, such as assessments to be completed, either automatically or in conjunction with input from the client administrator, managers, and/or leaders. In the present embodiment, target values are created by the system administrator and/or the client administrator module 510 and provided to the users. For example, sets of target values may be assigned to each role and stored in the database 112. The client administrator module 510 may override the role recommendations and/or change target values.

Job roles for a single participant may vary from assessment to assessment, for example due to different job duties for the participant. In addition, the client administrator module 510 may automatically associate a title with one or more job roles. The information generated by the client administrator module 510 and the system administrator module 410 may be stored in the database 112, such as associated with relevant accounts.

With continued reference to FIG. 5, the client administrator module 510 may provide a client administrator interface to permit the client administrator personnel to control authorized functions of the assessment system 100. In one embodiment, the client administrator module 510 provides a client administrator interface on a remote computer, such as a client administrator dashboard 516 providing options for controlling authorized functions, such as client administrator account management 518, participant entity profile information 520, employee information 520, team information 520, assessments 522, and results 524. The client administrator module 510 may comprise, however, any appropriate functions, and may be presented in any appropriate manner, such as a graphical user interface, drop-down menus, and/or a series of selections and input fields.

In the present embodiment, the client administrator dashboard 516 includes position options for establishing accounts for personnel associated with the participant entity, such as leaders, administrators, managers, and employees 520. Individual accounts may be associated with multiple positions and job roles. The client administrator dashboard may request and store any suitable information, such as each individual's name, contact information including email address, team name, manager's name, and position(s). The client administrator module 510 may automatically assign one or more user roles associated with permissions to each account according to their position or other criteria. For example, leaders may be permitted to view reports for the participant entity. Managers may be permitted to view results for themselves and their teams, but not other teams. Employees may be permitted to view their own results, but no other results except as authorized by relevant leaders and/or managers.

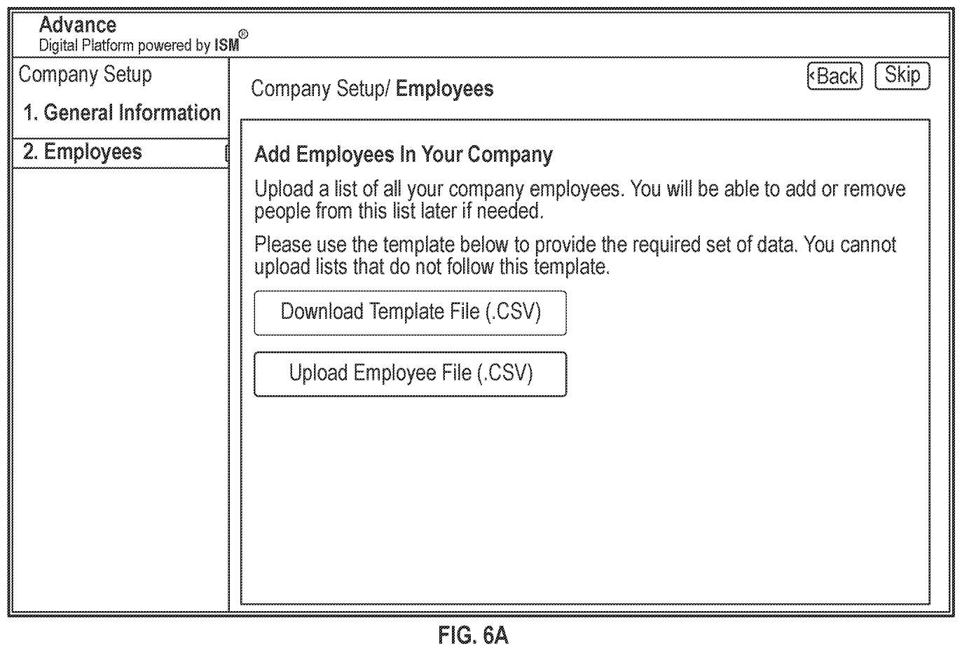

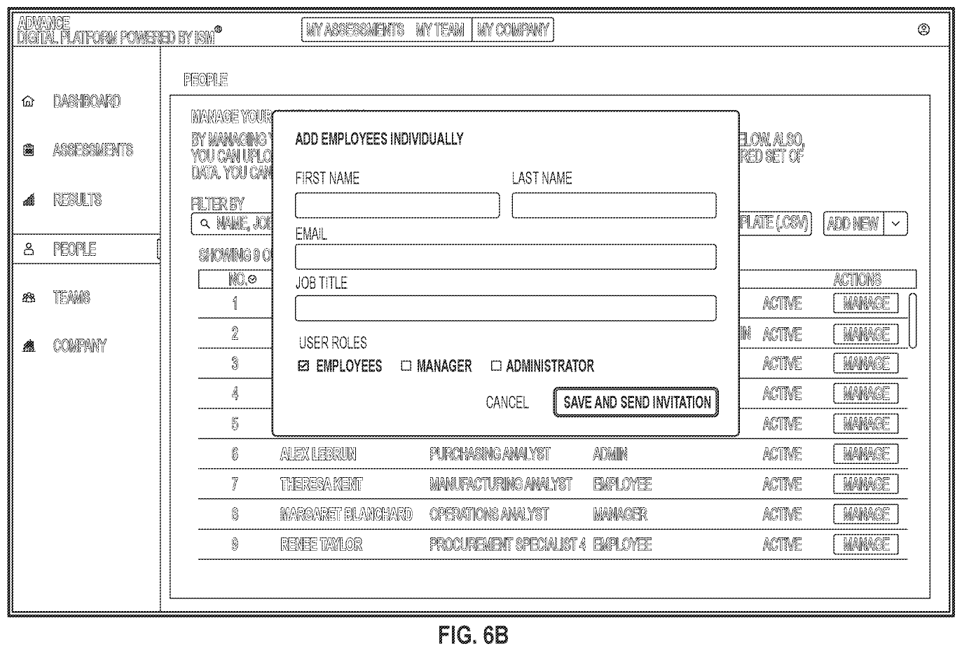

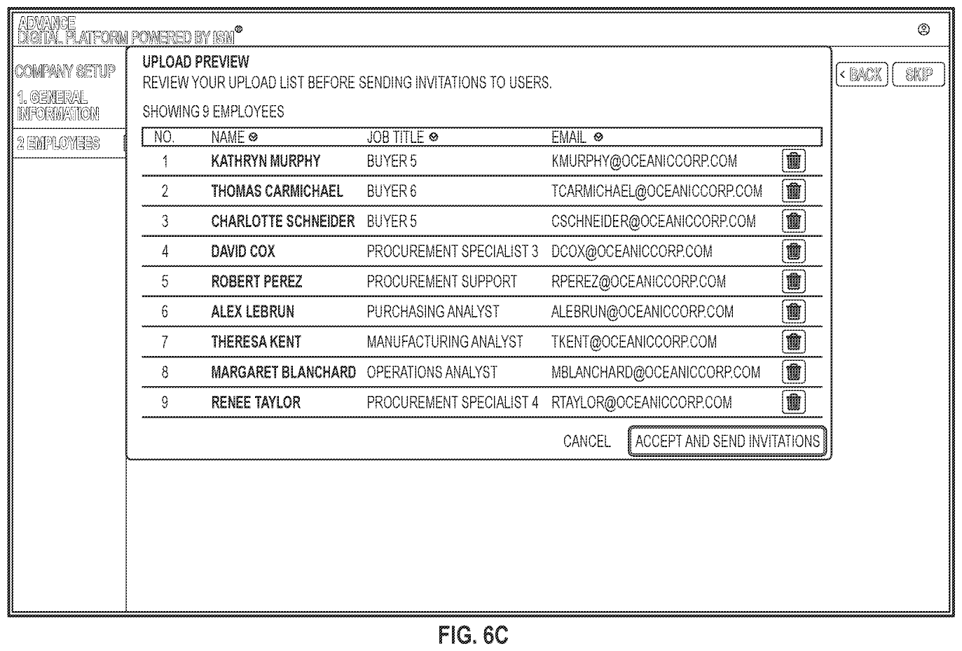

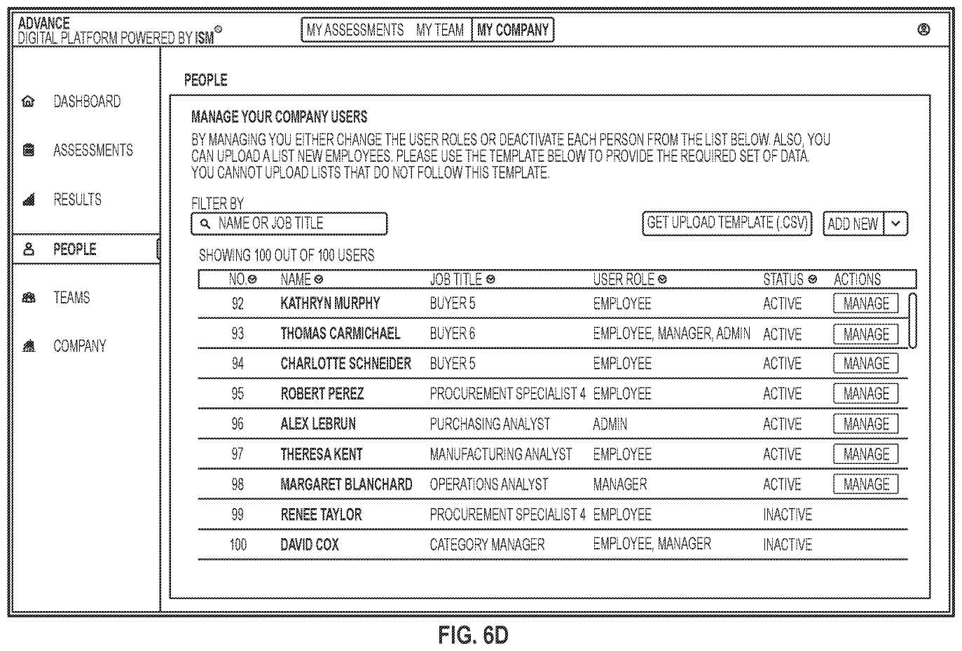

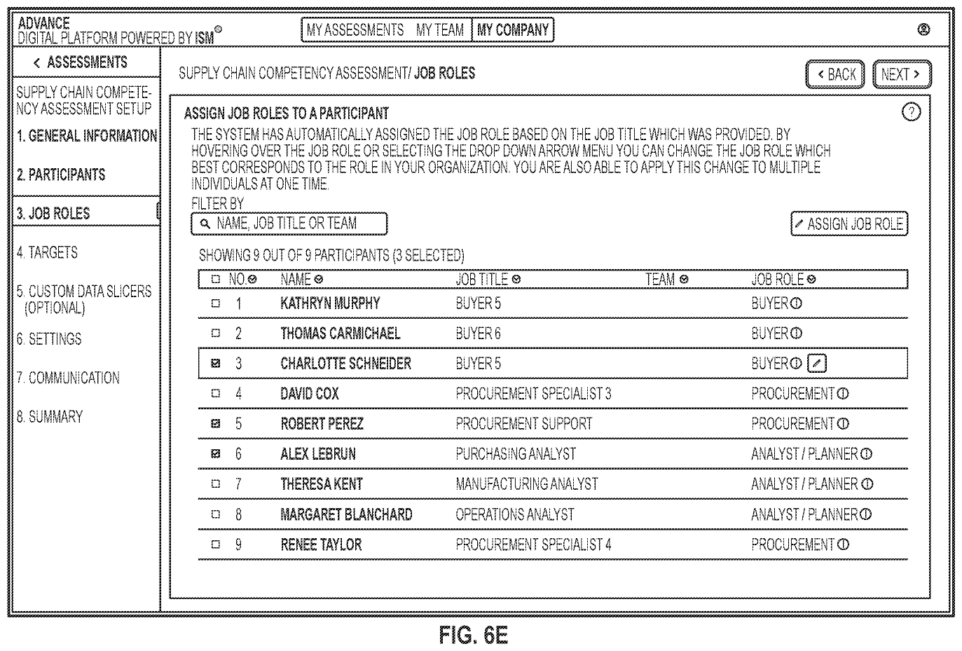

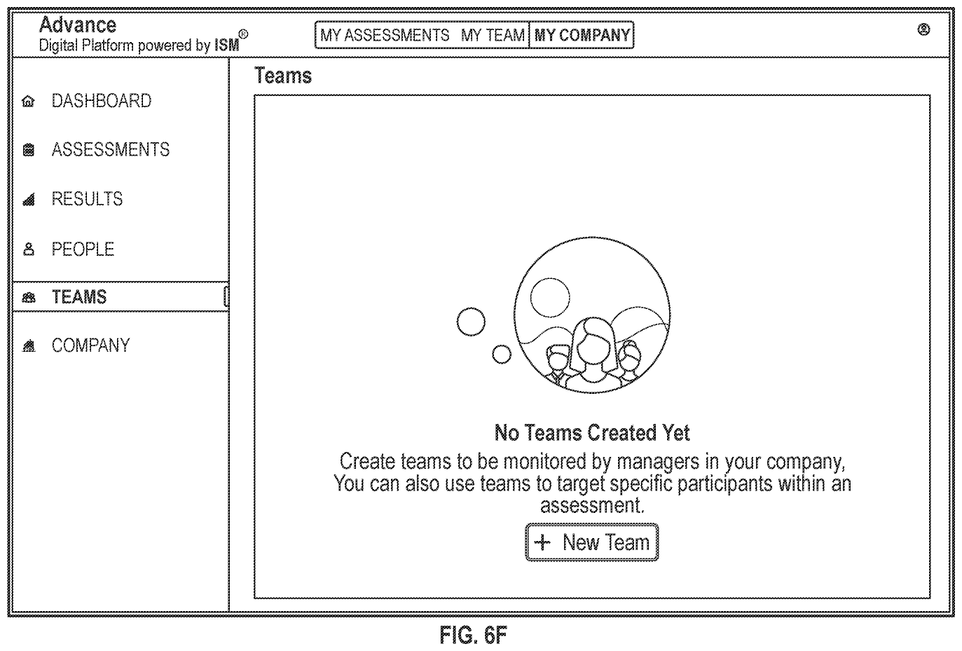

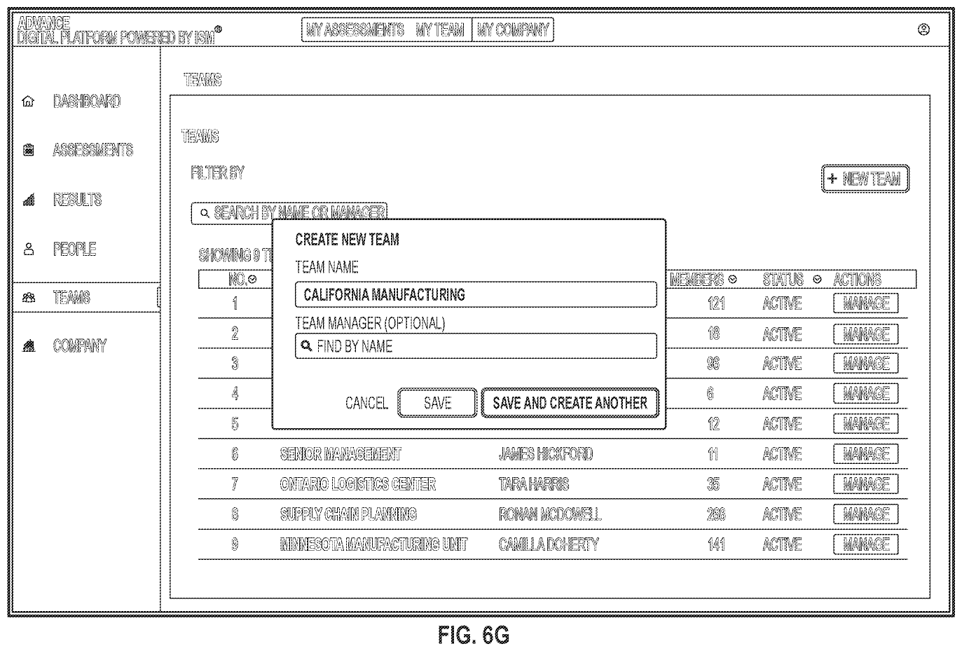

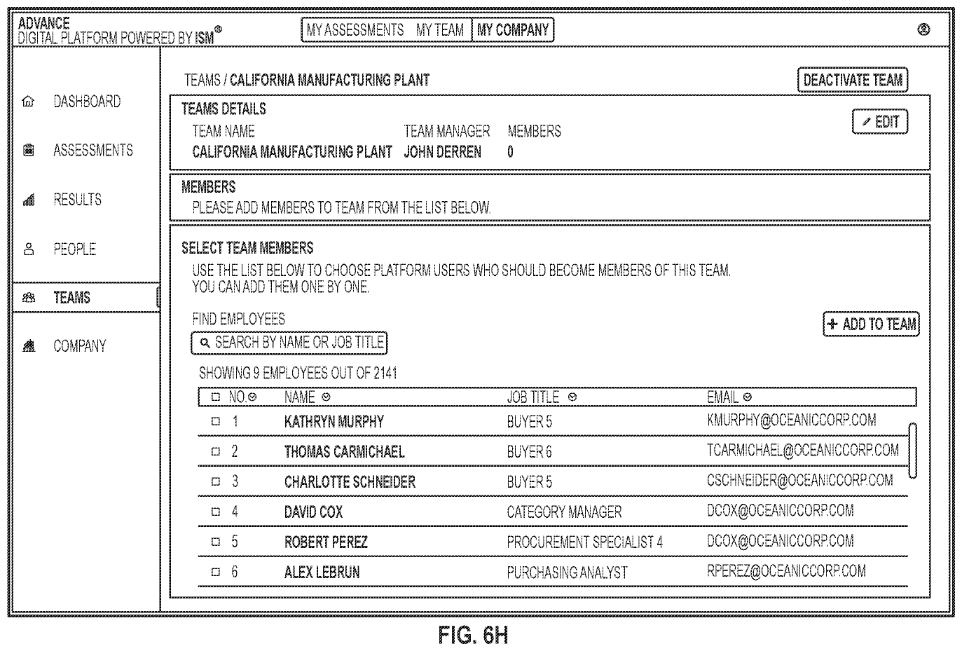

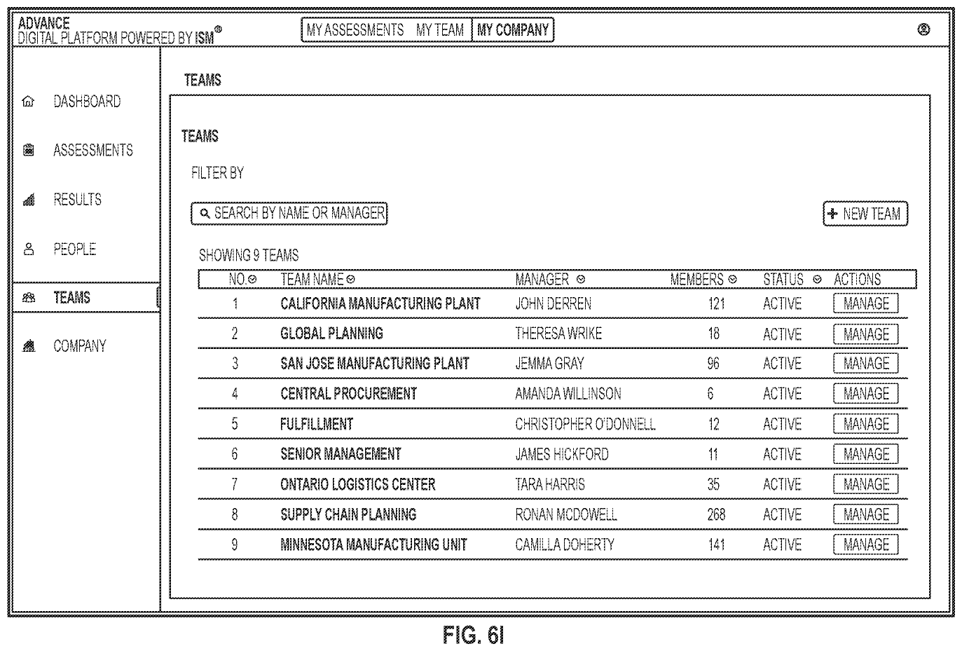

In one embodiment, referred to FIGS. 6A-I, the client administrator interface may allow participant entity personnel accounts to be added (FIG. 6A) in any suitable manner, such as manual data entry (FIG. 6B) or upload from a spreadsheet (FIG. 6C), and may allow them to be viewed, sorted, edited, searched, filtered, and removed (FIG. 6D). The client administrator module 510 may also automatically provide information, such as by assigning job roles to participant entity personnel according to any suitable criteria, such as title, job description, team description, department, years of experience, and the like (FIG. 6E).

The client administrator interface may also allow participant entity teams to be added in any suitable manner (FIG. 6F-H), such as manual data entry or upload from a spreadsheet, and may allow them to be viewed, sorted, edited, searched, filtered, and removed (FIG. 61). The information associated with each team may comprise any appropriate data, such as the team name, the manager's name and email address, and the employees associated with the team.

Referring again to FIG. 5, the client administrator interface may control the creation, launching, monitoring, and completion of assessments 522. For example, the client administrator interface may allow the client administrator to view assessments associated with the participant entity, such as assessments in progress, upcoming, and completed, and may allow the assessments to be searched, sorted, filtered, edited, and deleted. The client administrator interface may further permit the client administrator personnel to view details for the listed assessments, such as the status, subject matter, teams and employees, dates, and the like.

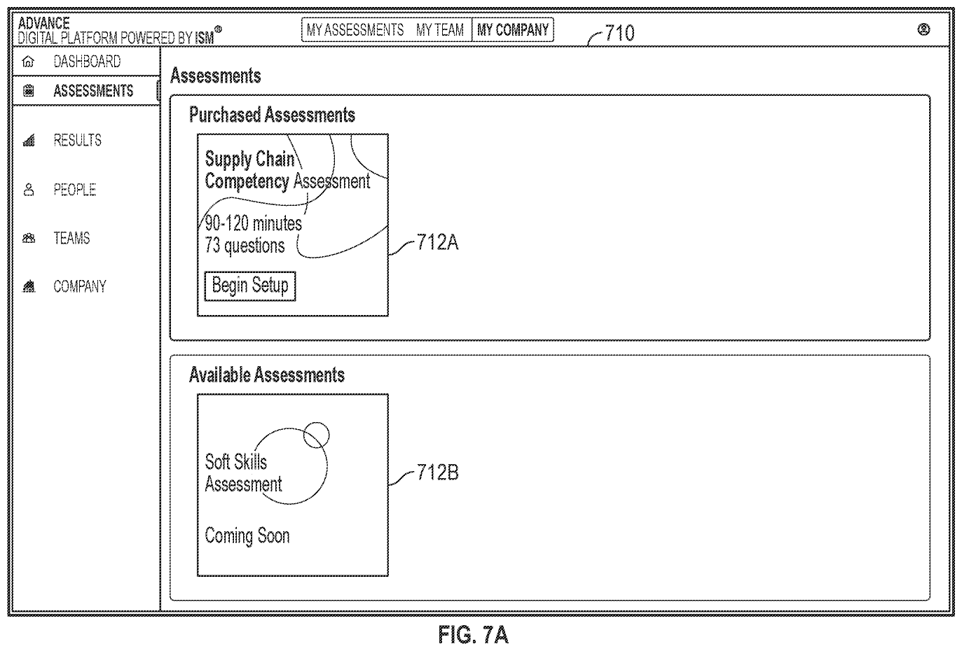

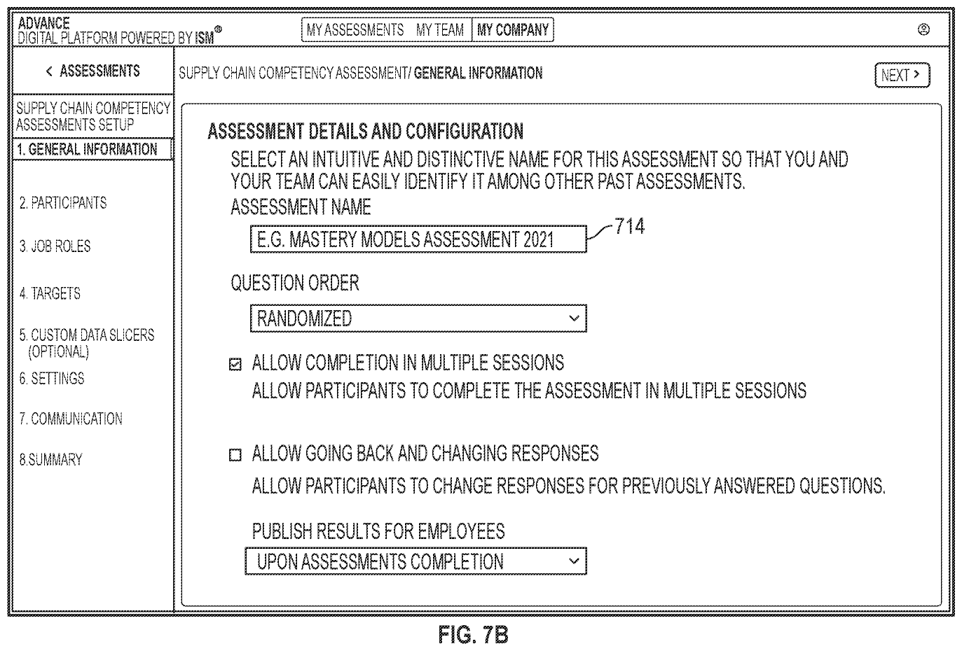

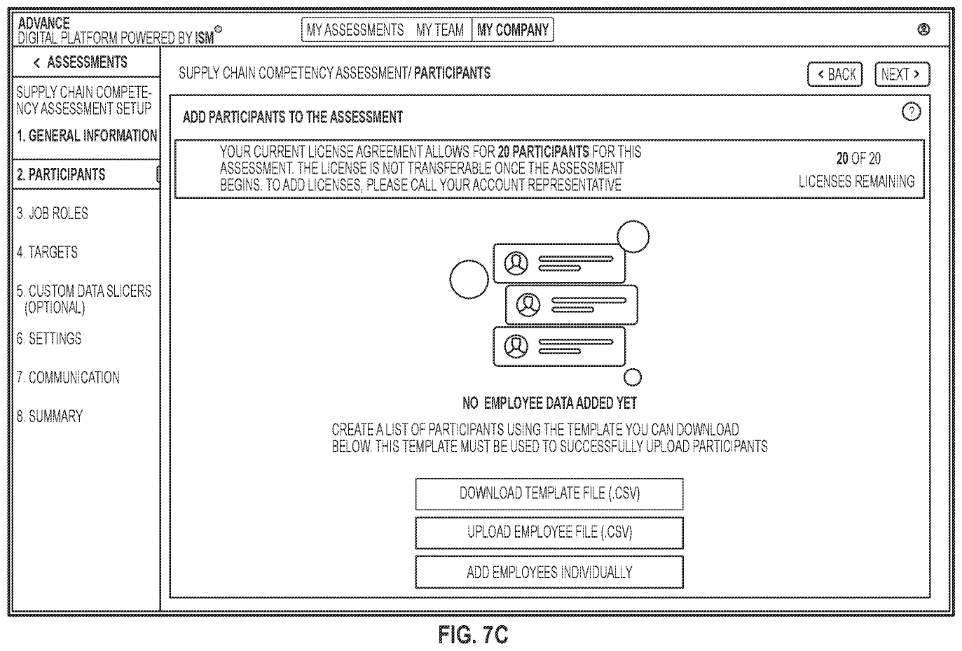

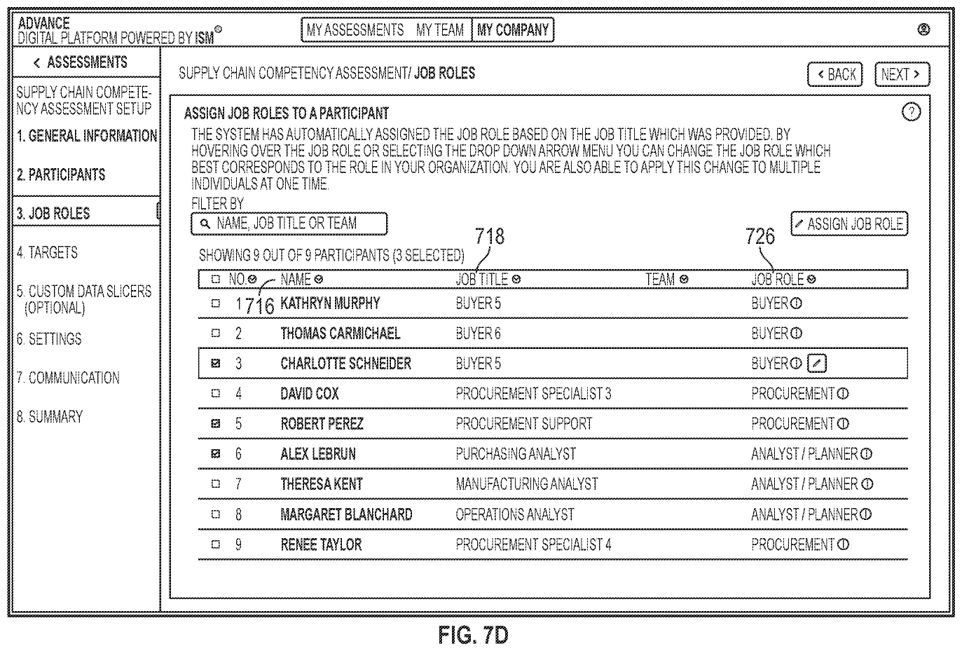

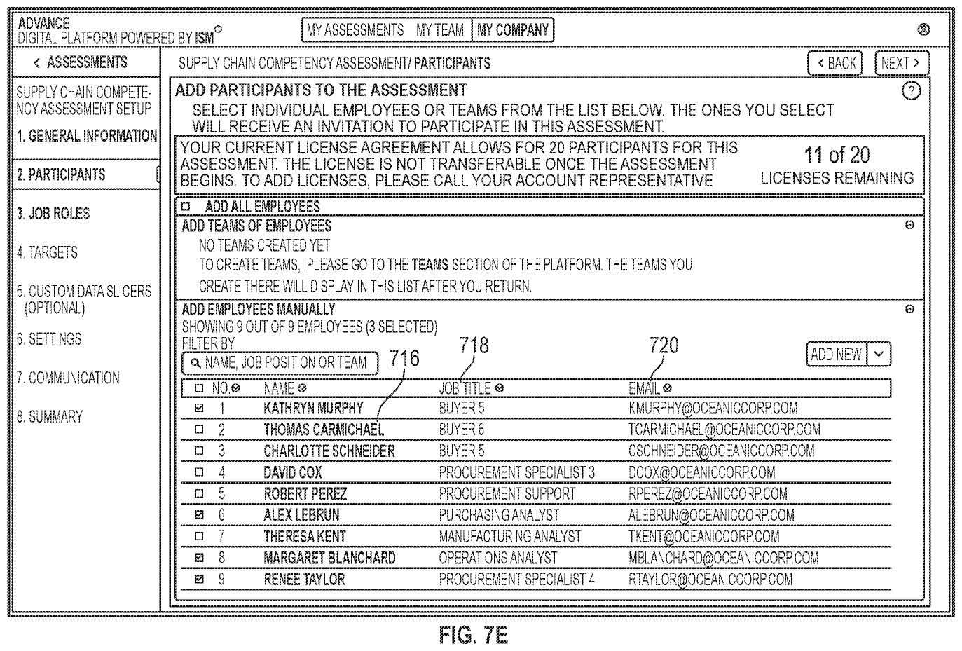

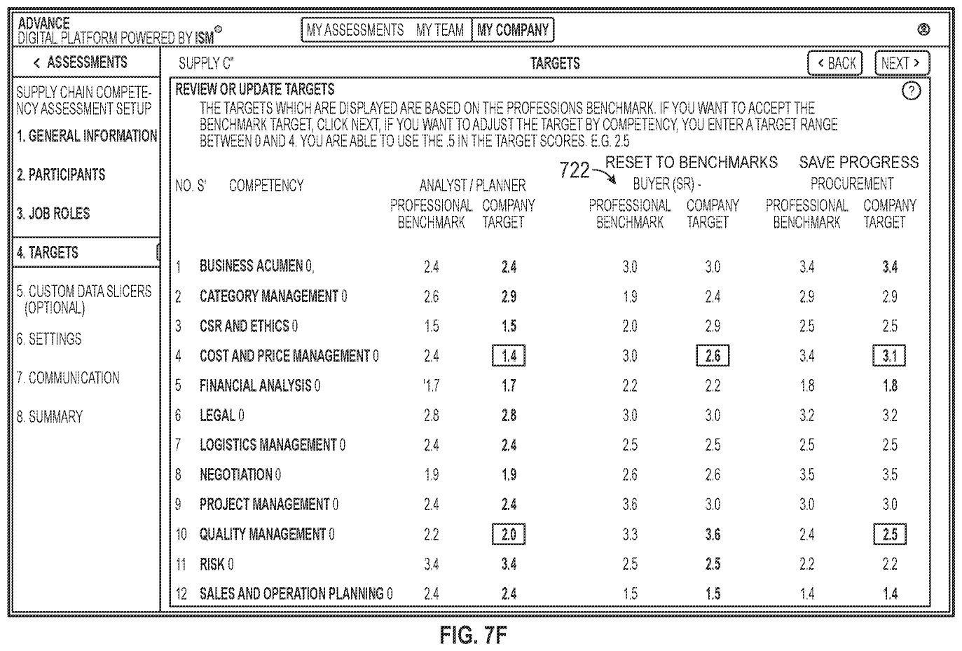

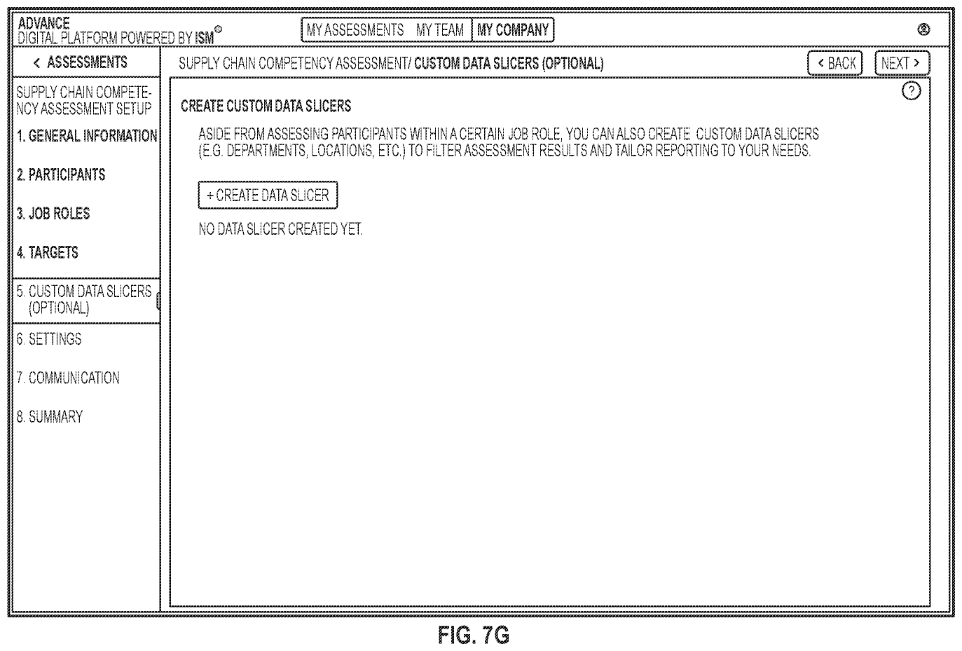

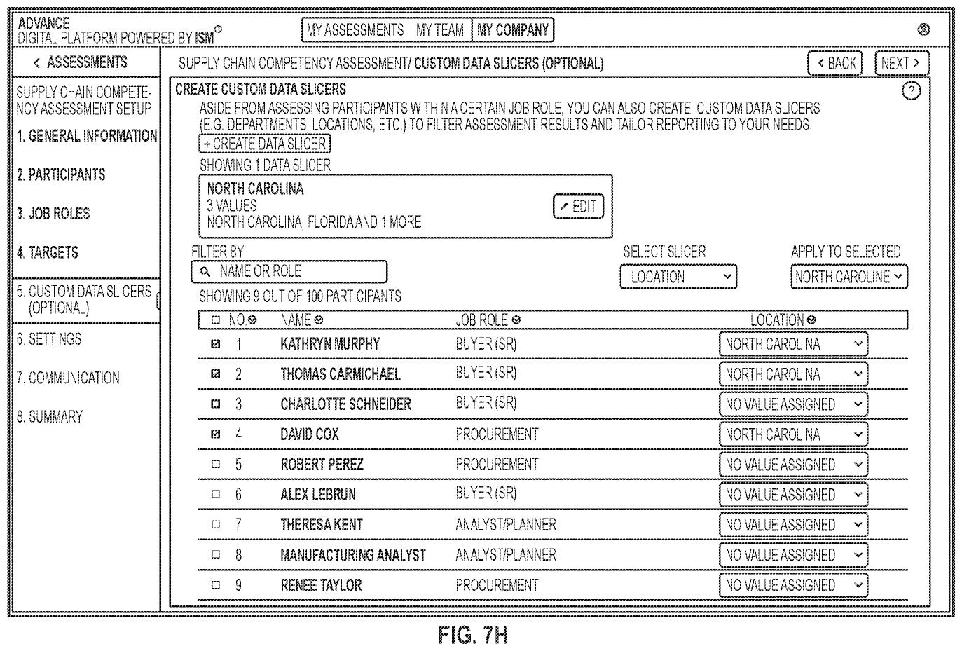

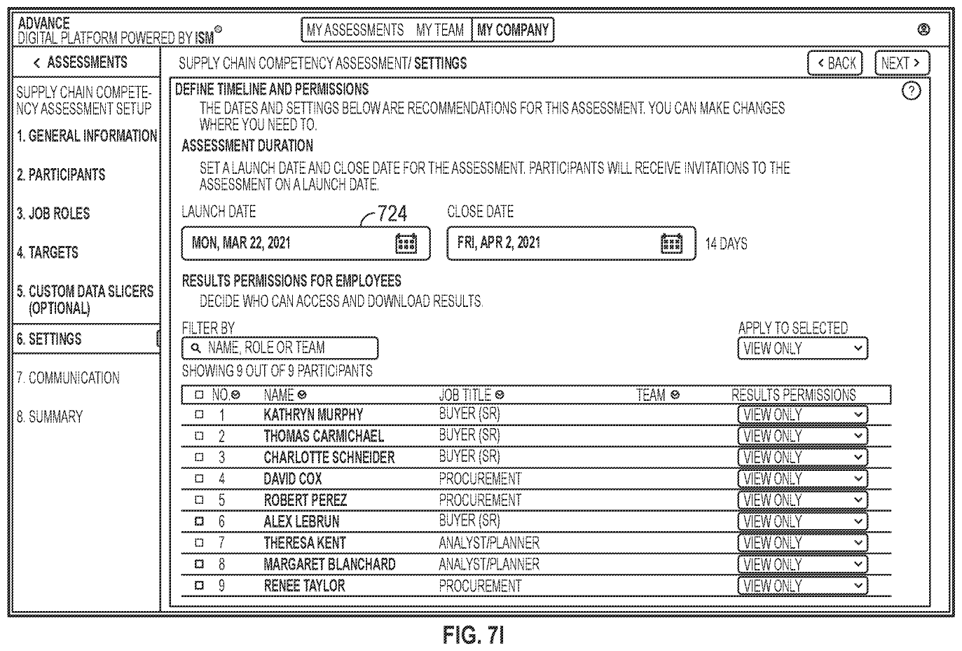

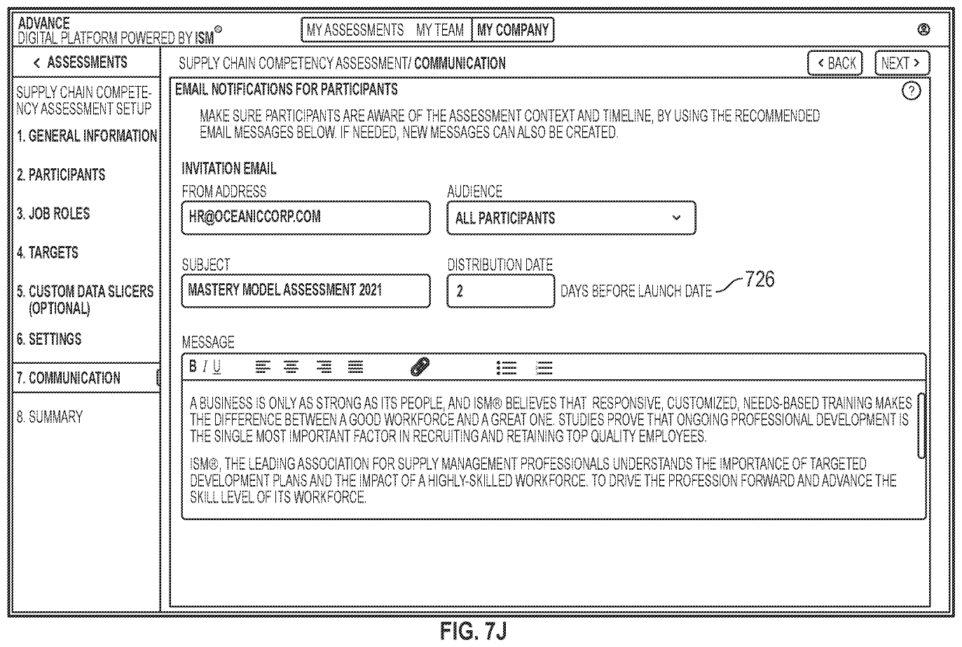

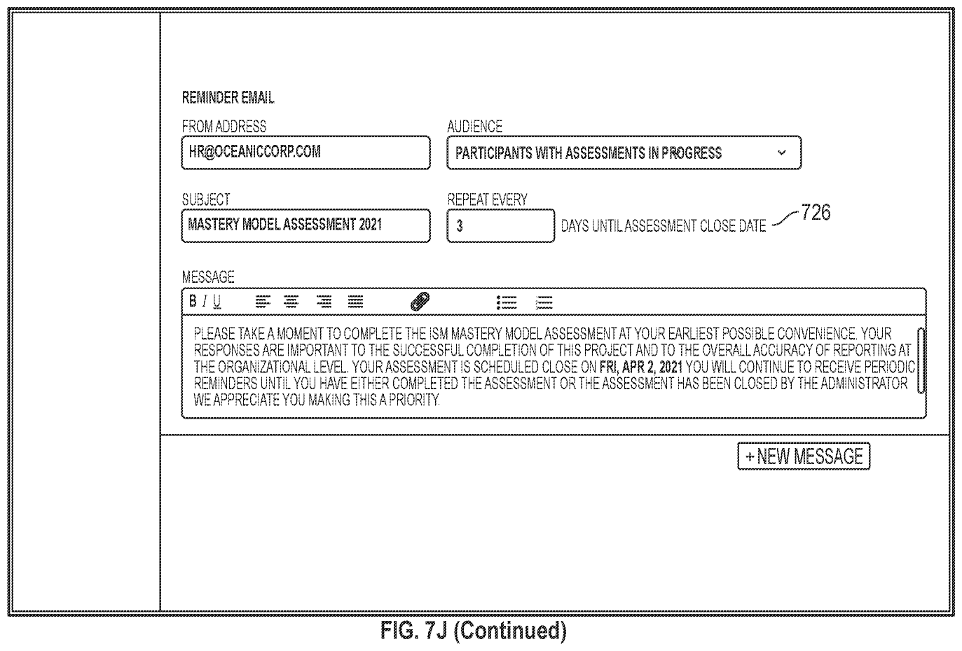

The client administrator interface may also facilitate creation of new assessments. The client administrator interface may allow the client administrator to create assessments in any suitable manner, such as searching according to particular criteria or words, copying and revising prior assessments, selecting from a listing of available assessments, and/or using a template. Referring to FIGS. 7A-J, in one exemplary embodiment, the client administrator interface may provide a list of available assessments 712A-B and the client administrator may select the assessments of interest. The client administrator interface may also receive additional information relevant to the assessment, such as a name 714, start date 724, number of participants, names of participants 716, job titles for different participants 718, job roles for different participants 726, participant contact information 720, and/or target values 722. The client administrator module 510 may also receive or automatically generate additional information for assessments, such as email addresses for participants and times and content for notifications regarding upcoming and launched assessments 726.

The client administrator interface may also allow the client administrator to create groups of participants and provide relevant information, such as a name for the group, a description, and the members of the group. Groups may be formed according to any criteria, such as role, location, and/or division. For example, creating groups may create alternative views of cohort results, such as to compare one team to another or one geographic region to another. The groups feature set may facilitate customized views and reports by providing additional data elements with which to cut data, customized reporting, and alternate views for reporting data.

After setup, the client administrator module 510 may allow the client administrator to launch the assessment. For example, the client administrator may select a launch option or launch date on the client administrator interface, which may automatically send email notifications to all of the participants with a link to begin the assessment, and the assessment may become available to the participants. The client administrator module 510 may also facilitate the client administrator taking surveys and otherwise participating in assessments 526. For example, the client administrator interface may list available and/or incomplete surveys and/or other aspects of assessments to be completed by the client administrator and allow the client administrator to take or continue taking such surveys or other aspects of an assessment.

The client administrator module 510 may also automatically send reminders to participants that have not yet begun or completed an assessment, such as at default times and/or times specified by the client administrator. When all of the participants have completed the assessment, the client administrator module may close the assessment, such as automatically or in response to a command from the client administrator via the client administrator interface.

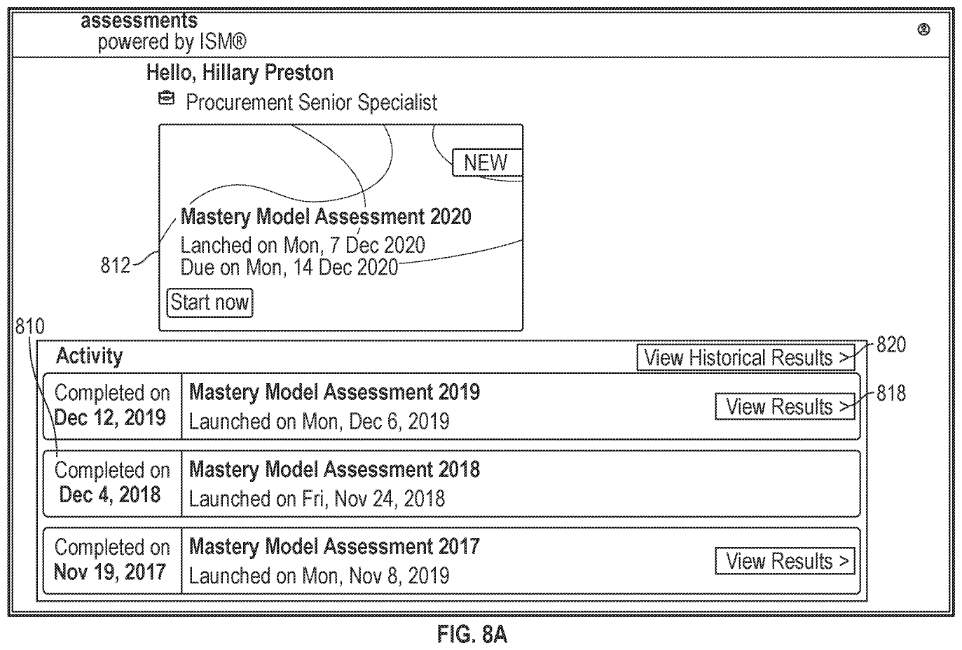

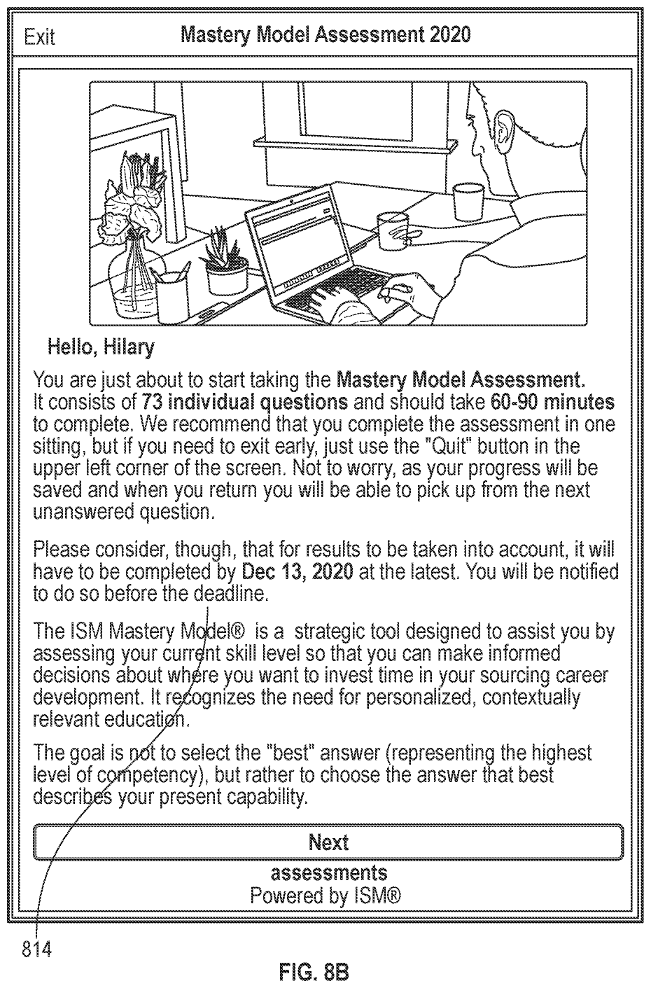

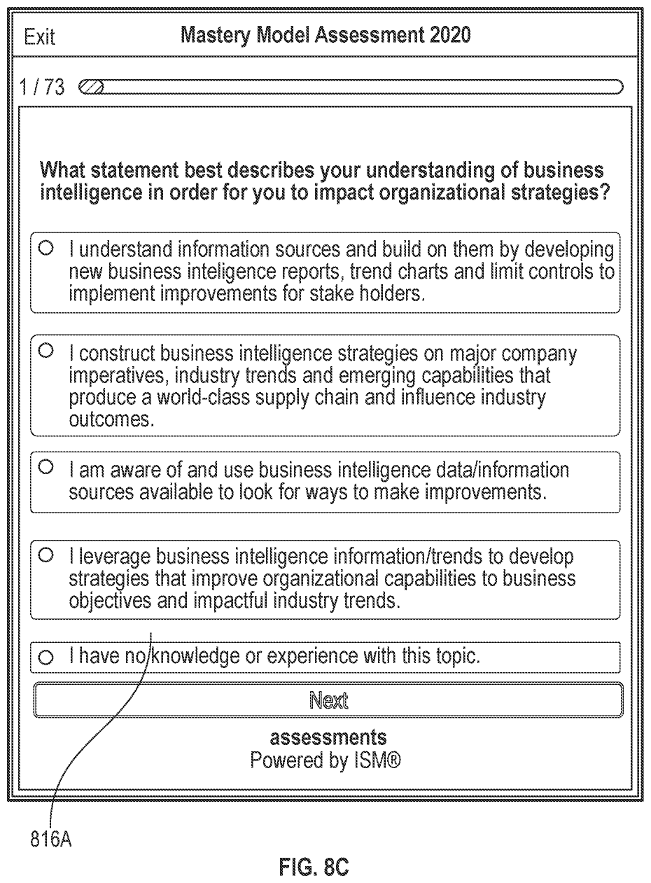

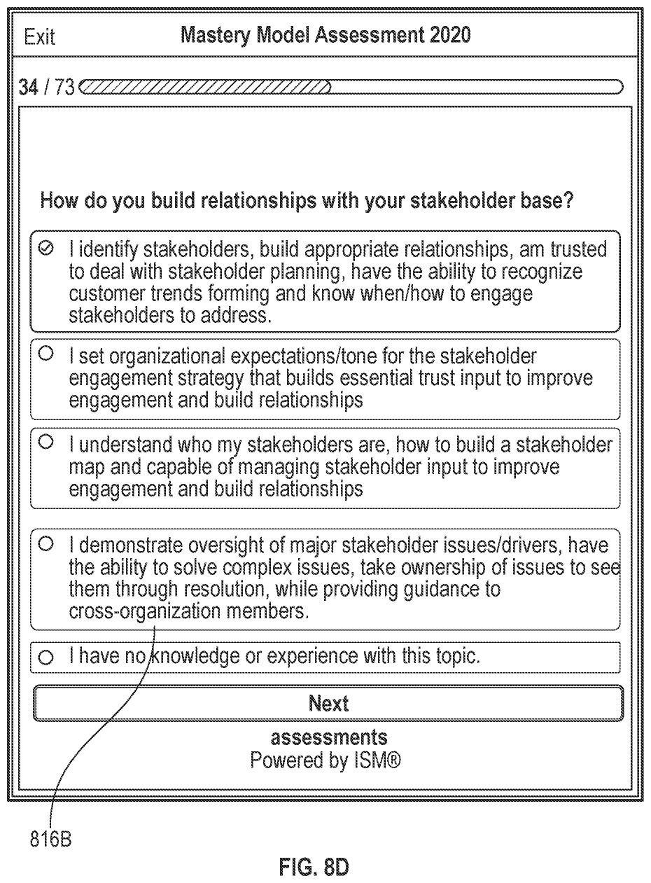

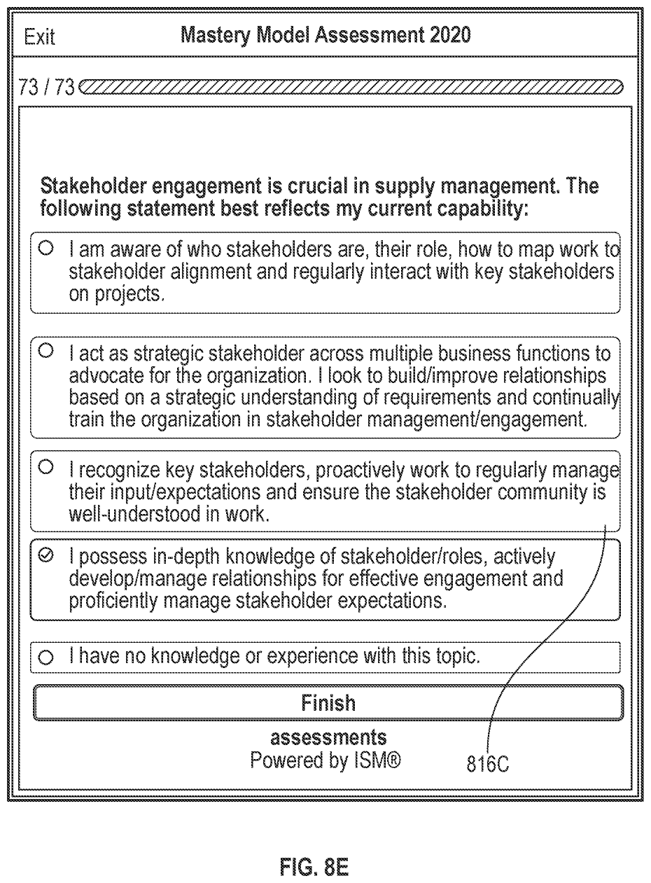

The assessments may be completed by the various personnel. For example, referring to FIGS. 8A-E, the server 110 may send links for employees to access their respective accounts and/or profiles, which may provide links to all assessments assigned to the employee and not yet completed 810. The employee may be required to take the assessment within a timeframe 812, such as in accordance with the timeline established by the client administrator setup module. If the deadline to complete an assessment is approaching, the assessment system 100 may provide automated prompts to complete the assessment.

The assessments may be provided and completed in any appropriate manner, such as via surveys or tests conducted via computer. For example, the employee may be given information regarding a survey 814 accompanied by questions 816A-C to be answered in one or more relevant talent fields, such as business intelligence. The answers provided by the user are stored by the server 110 and compared to correct or optimized answers to determine whether an answer is appropriate to create results, which may also be stored by the server 110.

The content of the assessments may be selected according to any suitable criteria, such as the job roles associated with the assessment and the skill levels of the respondents. The content may be selected according to any appropriate field, practice area, or profession. In the present exemplary embodiment relating to supply chain management, the content may be associated with competencies such as business acumen, social responsibility and ethics, leadership, cost and price management, financial analysis, legal, logistics management, supply chain planning, and other areas of competency for supply chain management. The competencies may include sub-competencies to be tested as well. For example, the competency relating to cost and price management may include subcompetencies such as cost, portfolio analysis, price, and total cost of ownership (TCO). The content may be designed to test the knowledge, logic, reasoning, experience, and/or other aspects of the user's talent in the particular competency and/or subcompetency.

In various embodiments, the assessments may include functionality for various question types, including abstract reasoning, right/wrong answers, multiple choice, scenarios, situational analysis, and simulations. The assessment system 100 may identify patterns for all question types, and the assessment may be available under a set time limit.

The results of the users' assessments may be stored by the server 110, such as in the database 112. The results may be provided to the user, the user's manager, the client leader, the client administrator, the system administrator, and/or any other relevant parties. In various embodiments, the system administrator and/or the client administrator may manage organization permissions to determine which parties may access particular results. In the present embodiment, the client administrator interface may present a list of results, such as for a particular assessment, participant entity, team, industry, or other criteria. The client administrator interface may facilitate searching, sorting, filtering, viewing, downloading, or otherwise operating upon the results. In the present embodiment, the client administrator interface may provide an option for closing an assessment, such as when all results have been received for each participant, and automatically generating reports, recommendations, analyses, summaries, and other information including and derived from the data. The client administrator interface may also generate notifications, such as corresponding to completed assessments, survey reminders, and updates 528.

The assessment system 100 may implement a client manager module for controlling a participant entity manager's use of the assessment system 100. The client manager module may allow a client manager, such as a team manager for the participant entity, to control authorized elements of the assessment system 100, such as by editing team details, adding and removing employees, reviewing and/or modifying employee information, monitoring assessments and surveys, and requesting and reviewing results.

The client manager module may set up and/or verify account information for the participant entity team and monitor assessments for the participant entity team. For example, the client manager may receive an invitation, such as an electronic communication with a link, to access the assessment system 100. When the client manager accepts the invitation, the client manager's computer or other device may contact the server 110 and access a client manager setup module. In various embodiments, the client manager setup module may prompt the client manager for information, such as team data and identifying information for employees to be assessed.

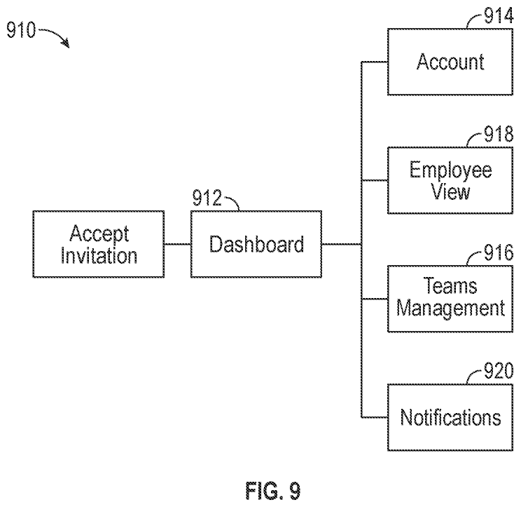

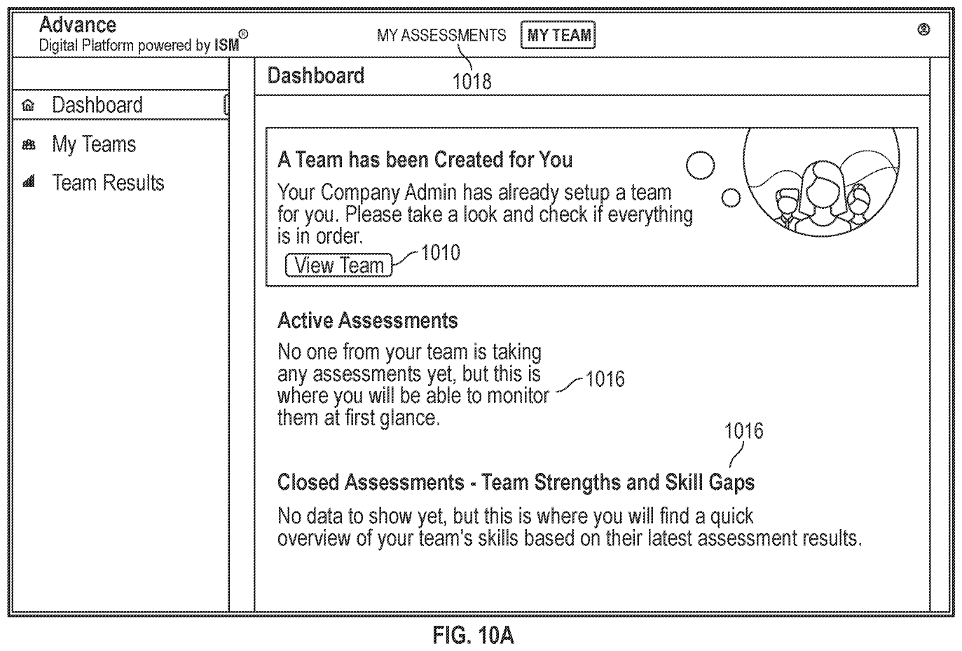

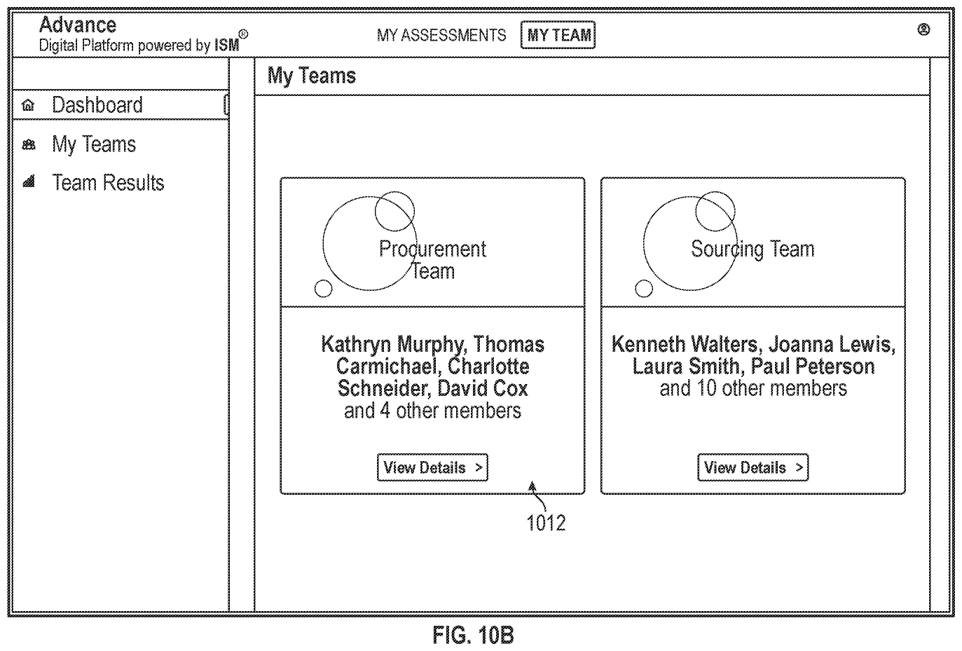

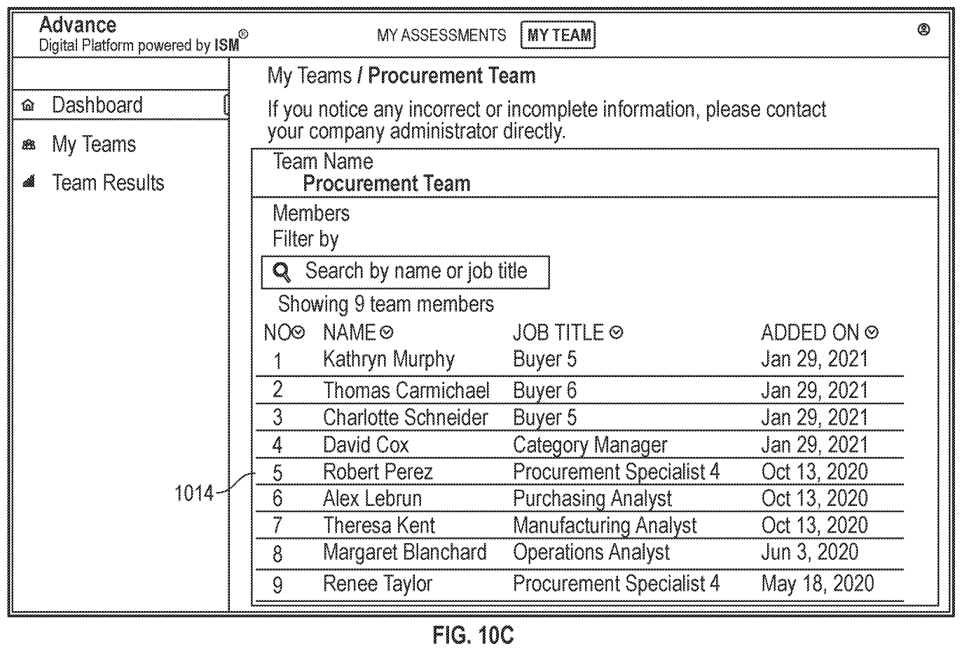

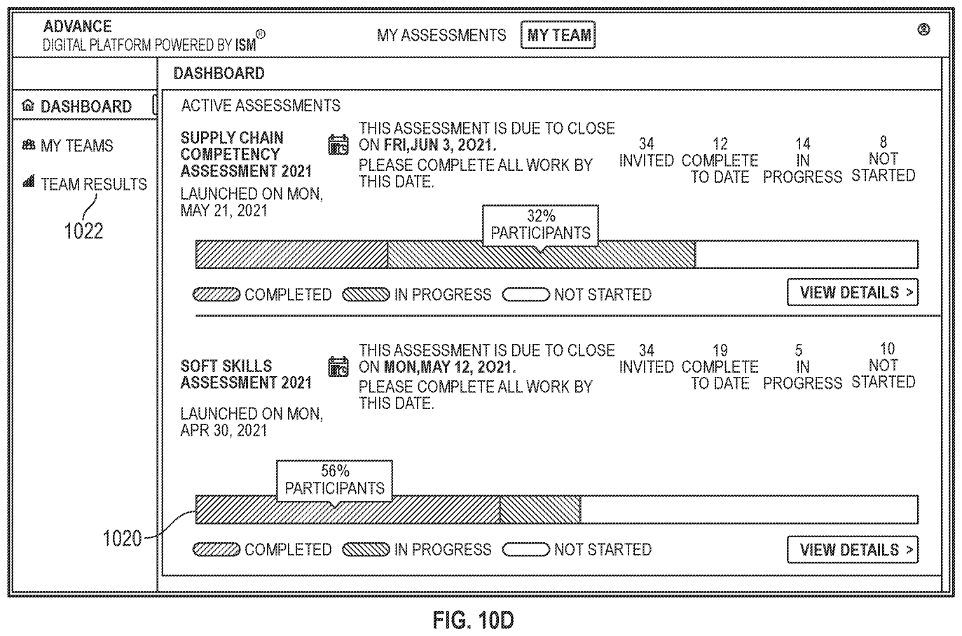

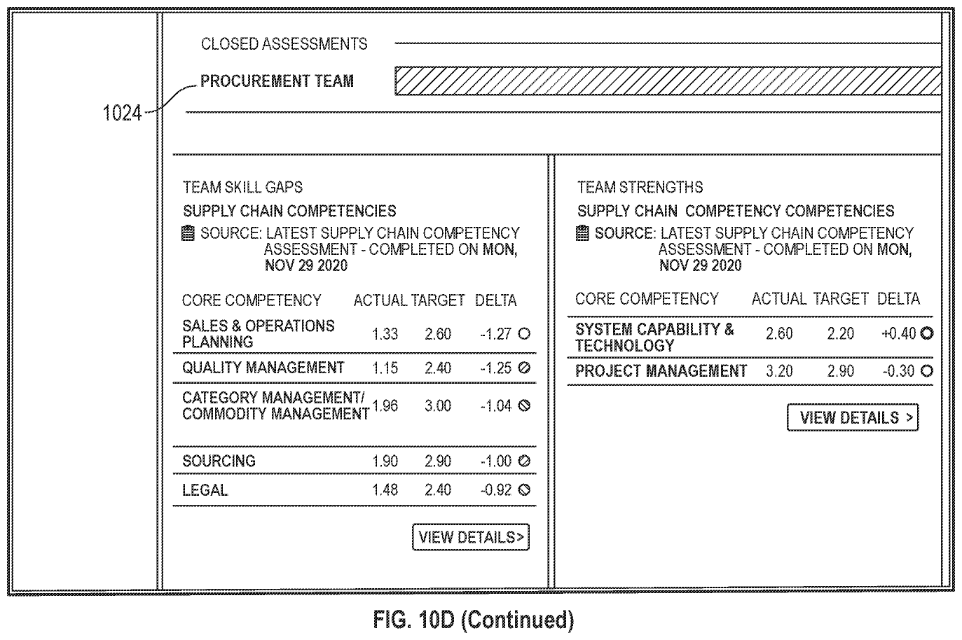

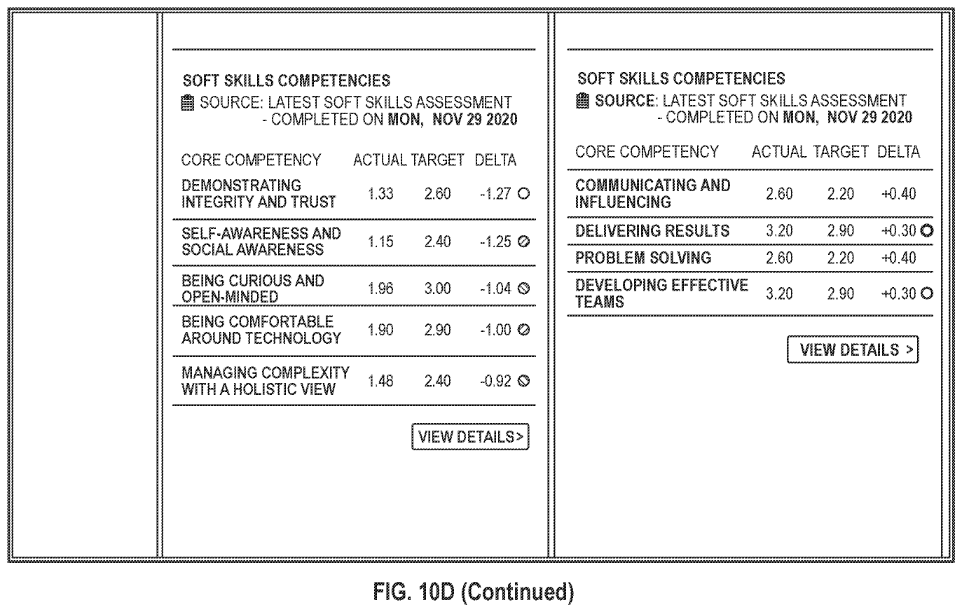

For example, referring to FIG. 9, an exemplary client manager module 910 according to various aspects of the present technology may provide a manager dashboard 912 with various options for controlling authorized functions of the assessment system 100, such as account management 914, creating and reviewing team information 916, viewing and taking assessments 918, reviewing assessment results, and viewing notifications 920. In the present embodiment, referring to FIGS. 10A-D, the manager dashboard provides options for viewing and editing the client manager's account, such as name, contact information, and password. The manager dashboard may also include options for creating and/or viewing the client manager's team 1010. For example, the manager dashboard may include an option for creating a new team, and the client manger may add, remove, and edit details of team members, such as the names and contact information for employees on the client manager's teams 1012. The manager dashboard may also include options for searching, sorting, filtering, viewing, adding, removing, and editing team members 1014 for new teams and existing teams.

The manager dashboard may also facilitate managing assessments, such as for the client manager and/or team members 1016. For example, the manager dashboard may provide an option to view assessments in which the client manager is a participant and taking a survey 1018, and may include a list of available surveys, partially completed surveys awaiting completion, opportunities to begin or resume taking surveys. The surveys available to the client manager may include managerial assessments of team members. The manager dashboard may also provide the status and/or progress of team member assessments, including completed assessments 1024, partially completed assessments, and not-yet-begun assessments assigned to team members 1020.

The manager interface may also provide access to results 1022, such as for the overall team, individual team members, and/or the client manager. For example, the manager dashboard may provide links to view and/or download such results and associated information, such as dates of completion and duration of surveys. The manager dashboard may also facilitate searching, sorting, filtering, and viewing such results, such as according to the name, job titles, and/or job roles of team members.

The manager interface may further provide any suitable functionality for managing the assessments for a team. In the present embodiment, the manager dashboard provides notifications relating to assessments, such as outstanding surveys for team awaiting completion, upcoming deadlines for surveys, updates on team status from the client administration or system administrator, team and/or personal results reports, team and/or personal progress reports, and/or notifications for the client manager or team members to take new survey.

The assessment system 100 may implement a client employee module for controlling a participant entity user's, such as an employee's, use of the assessment system 100. The client employee module may allow a client user, such as a team member, employee, or other user associated with the participant entity, to control authorized elements of the assessment system 100, such as by reviewing and/or modifying user information, taking surveys, and requesting and reviewing results.

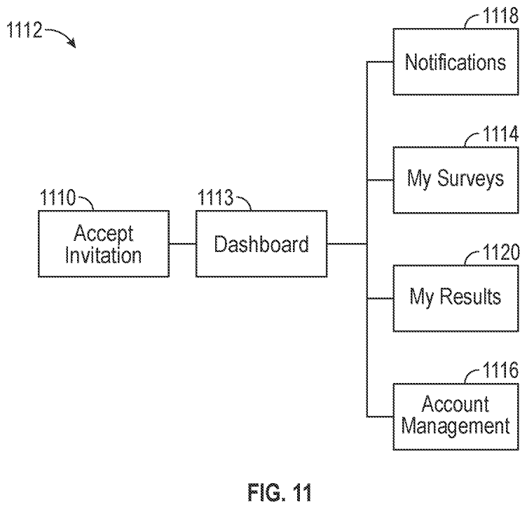

The client employee module may set up and/or verify account information for the participant entity user and monitor assessments for the participant entity user. For example, referring to FIG. 11, the user may receive an invitation, such as an electronic communication with a link, to access the assessment system 100. When the user accepts the invitation 1110, the user's computer or other device may contact the server 110 and access the client employee setup module. In various embodiments, the client employee setup module may prompt the user for information, such as user data, identifying information, and/or a password.

For example, a client employee module 1112 according to various aspects of the present technology may provide an employee dashboard 1113 with various options for controlling authorized functions of the assessment system 100, such as viewing and taking surveys, account information, notifications, and survey history and results. The client employee module 1112 may provide any suitable information and functions, however, according to the environment and application of the assessment system 100.

In the present embodiment, the client employee module 1112 provides the employee dashboard 1113 as a graphical user interface providing information and control options. For example, the employee dashboard 1113 may provide options for controlling the user's account 1116, such as to view and/or revise the user's name, login information including password, contact information, and login/sign out options. The employee dashboard may also provide notifications 1118, such as to take a new survey, complete a partially completed survey, approaching deadlines, and/or view results.

The client employee module 1112 may also facilitate taking surveys and reviewing results. For example, the employee dashboard may provide a survey history showing surveys to be taken, partially completed, and completed 1114. For surveys to be taken or partially completed, the employee dashboard may facilitate starting or resuming a survey.

Surveys may be presented and taken in any appropriate manner, such as via a series of questions or situations presented to the user and responses provided by the user. For example, referring again to FIGS. 8B-E, the employee interface may provide information relating to a survey, such as a short description, rules, and available time to complete (FIG. 8B). The user may begin the survey and view requests for responses and provide corresponding responses (FIGS. 8C-E). For example, the survey may comprise a series of multiple-choice questions, and the user may provide responses by designating selections. The survey may prompt responses from the user, however, in any suitable manner. As the user provides responses, the server 110 stores the responses. When the user completes the survey, the status for the user's survey may be updated to completed.

In various embodiments, the user may view the results of completed surveys 1120. For example, the employee dashboard 1113 may provide a survey history showing completed surveys, and the user may select results to be reviewed, such as by viewing or downloading the results of individual surveys 818 or multiple surveys over time 820 (FIG. 8A). The employee dashboard may also offer any other suitable functionality, such as functions for searching, sorting, filtering, downloading, and viewing results for the user.

The assessment system 100 may accommodate users that are not associated with a larger participant entity or in differently organized participant entities. For example, in a business-to-consumer model where the individual user is the participant entity, the assessment system 100 may implement an individual customer module for controlling an individual customer's use of the assessment system 100. The individual customer module may allow an individual customer to control authorized elements of the assessment system 100, such as by reviewing and/or modifying individual customer information, setting up surveys, taking surveys, and requesting and reviewing results.

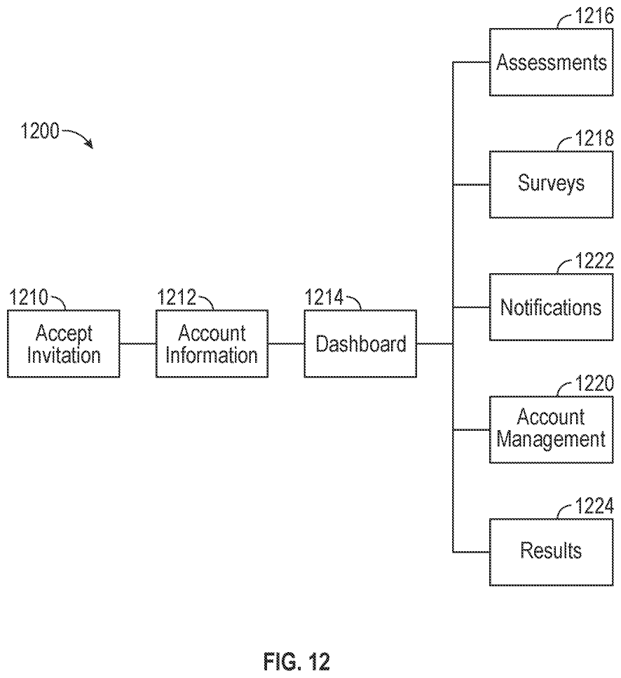

The individual customer module may set up and/or verify account information for the individual customer and monitor assessments for the individual customer. For example, referring to FIG. 12, the individual customer may receive an invitation, such as an electronic communication with a link, to access the assessment system 100. When the individual customer accepts the invitation 1210, the individual customer's computer or other device may contact the server 110, such as via a browser, and access an individual customer setup module. In various embodiments, the individual customer setup module may prompt the individual customer for information, such as user data, identifying information, and/or a password 1212.

An individual customer module 1200 according to various aspects of the present technology may provide an individual customer dashboard 1214 with various options for controlling authorized functions of the assessment system 100, such as creating assessments 1216, viewing and taking surveys 1218, account information 1220, notifications 1222, survey history, and results 1224. The individual customer module 1200 may provide any suitable information and functions, however, according to the environment and application of the assessment system 100.

In the present embodiment, the individual customer dashboard 1214 may comprise a graphical user interface providing information and control options. For example, the individual customer dashboard 1214 may provide options for setting up the individual customer's account, creating and viewing assessments, selecting job roles, selecting target values, reviewing survey histories and results, taking and/or resuming surveys, viewing and/or responding to notifications, reviewing and/or downloading results, reports, and/or other outputs of the assessment system 100, and searching, sorting, filtering, viewing, downloading, adding, removing, and revising information as described in conjunction with the other modules. The individual customer module may incorporate any appropriate functions used by other modules, such as the client administrator module 510, client manager module 910, and the client employee module 1112.

When a user completes an assessment, other personnel, such as the client administrator, manager, and/or leader, may be notified that the assessment is complete. For example, various dashboards for different users may be updated with notifications that assessments are complete, such as according to authorizations and associations for the user. The assessment system 100 may automatically generate summary reports, store them with the appropriate accounts, and send them to selected personnel, such as the client leader, client administrator, client manager, and/or individual customer. In various embodiments, a simplified or limited summary may be provided to the client manager and/or client employee.

The reports may be in multiple formats to provide a clear analysis and summary of the results. Report generation may be automated and provided in a visual format to indicate the results, and gaps to relevant target values, such as benchmarks. Results may be represented visually to communicate the data to individuals, team leaders, administrators, and companies, such as graphically, in table form, and/or in spreadsheets. Reports and any other outputs may be noted for companies, leaders, and individuals, any may be associated with the appropriate accounts for access.

The results may include any appropriate data. For example, the following outputs may be created by the server 110 and stored within the company and appropriate accounts:
Individual Assessment Results
   Results by Competency
   Results by Sub-competency
Individual Competency Gaps (plus/delta) vs Manager View
   Gap by Competency
   Gap by Sub-competency
Individual Competency Gaps (plus/delta) vs Company Target Value
   Gap by Competency
   Gap by Sub-competency
Individual Competency Gaps (plus/delta) vs Benchmarks
   Gap by Competency
   Gap by Sub-competency
Organizational, Team, and/or Individual Cumulative/Aggregate Assessment Values
   Cumulative by Competency
   Cumulative by Sub-competency
   Cumulative by Role
   Cumulative by Job Title
   Cumulative by Functional Area
Results Compared to Objective Right/Wrong Answers

Leaders and/or other participant entity personnel may rank and adjust the importance of a competency, such as based on current and projected conditions, to see gaps. The server 110 may generate an automated organizational roadmap to address gaps, such as machine learning and leveraging the data input into accounts or profiles for the participant entity and results from the assessments. The results may highlight employee resources that are underutilized and indicate opportunities based on skills and competencies.

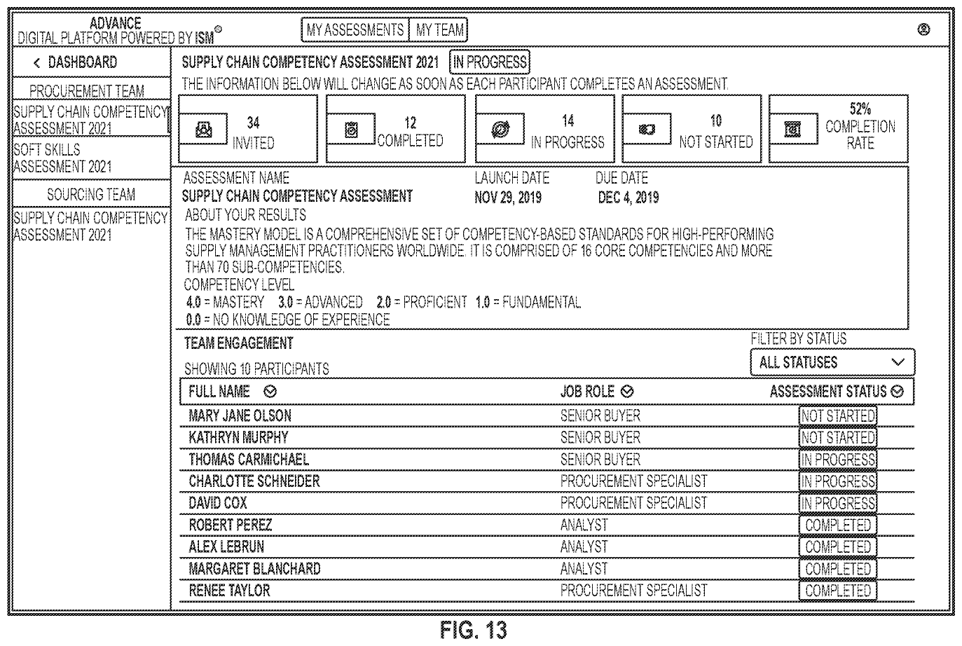

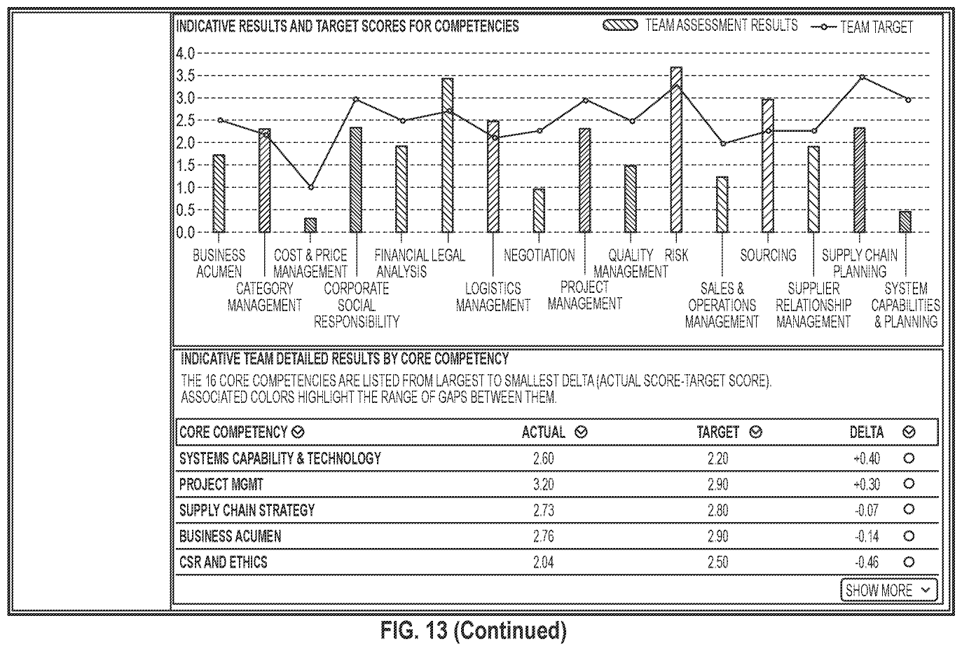

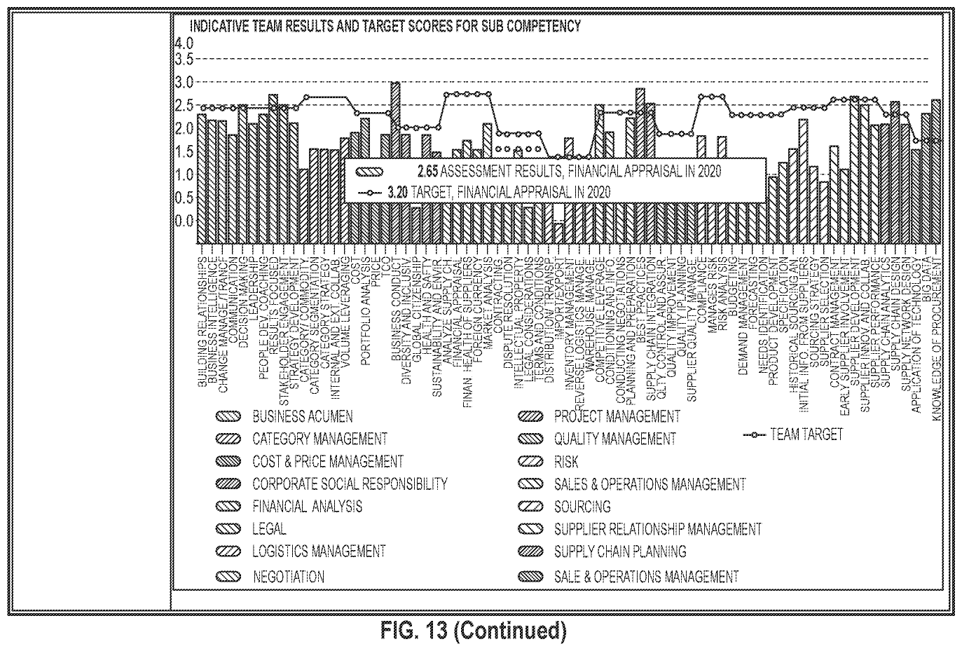

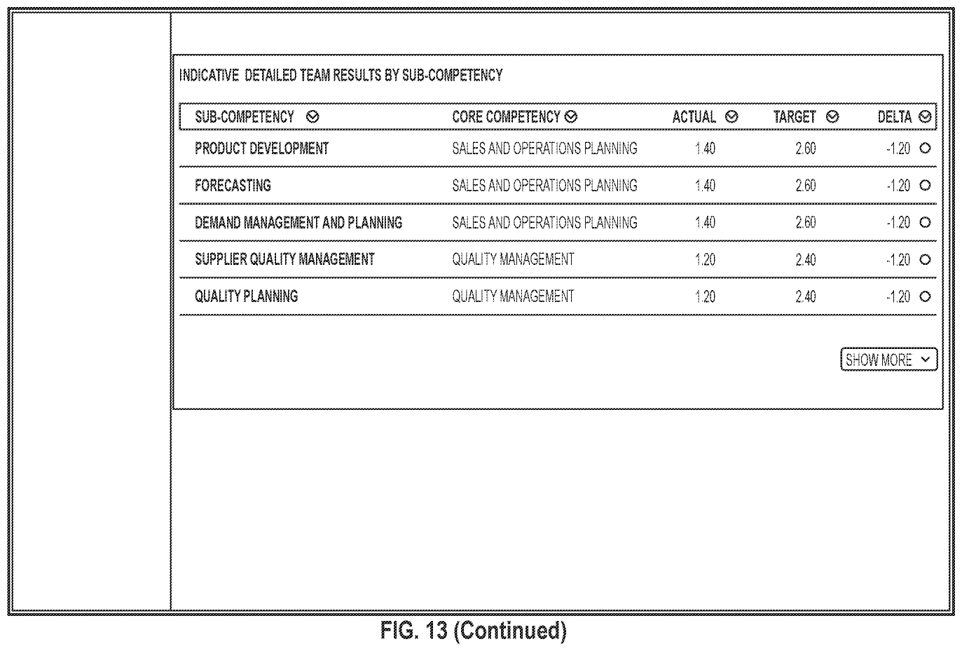

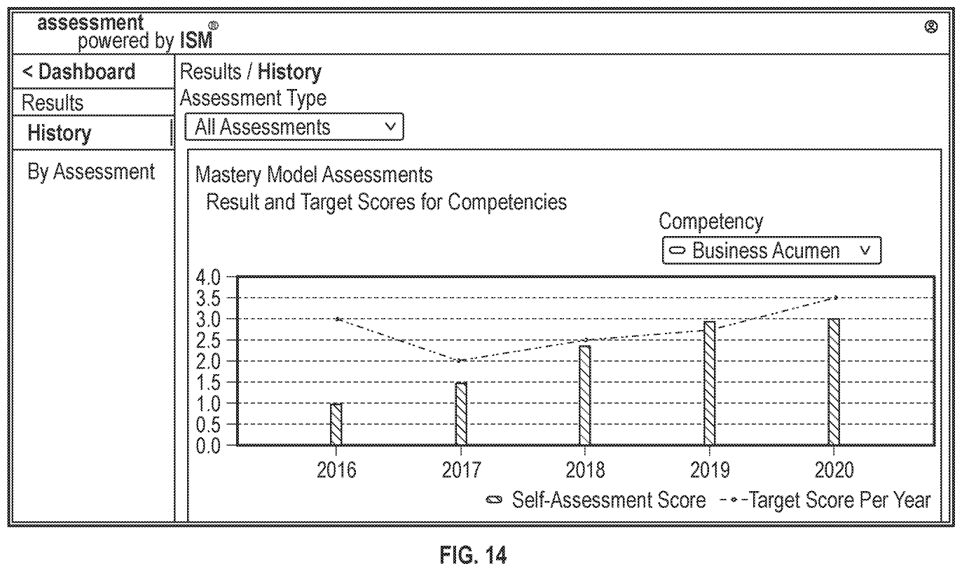

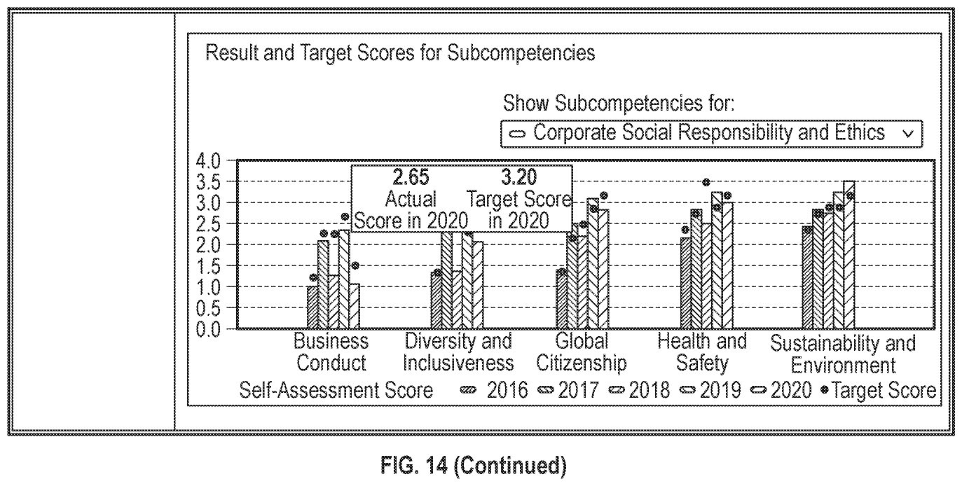

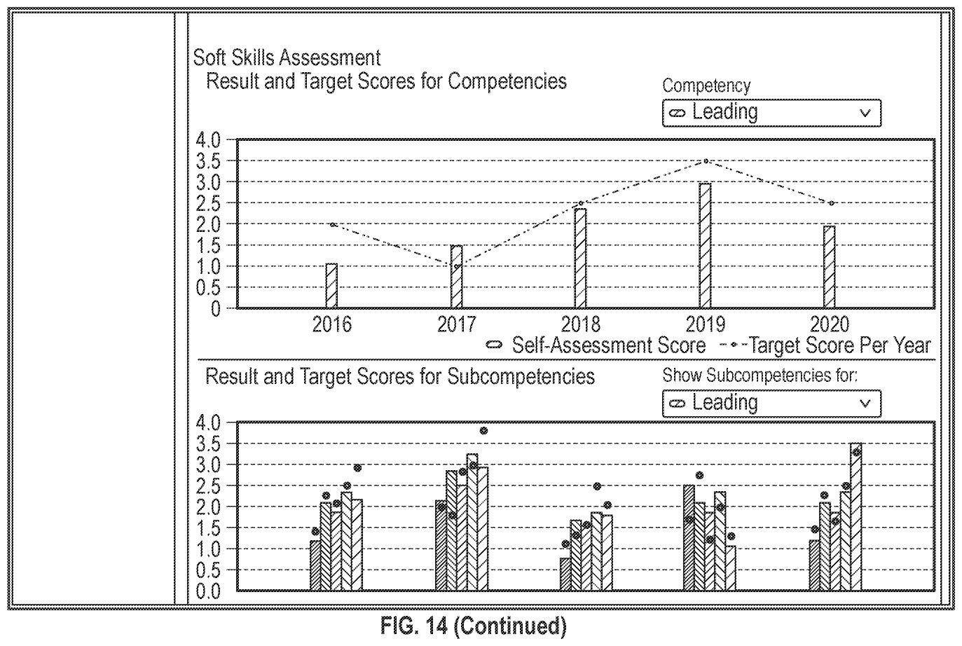

The results may be presented in any appropriate manner, such as electronically with comparisons to the users' personalized target values. For example, the results may be separated according to competencies and/or subcompetencies and compared to the user's target values and historical results. In one embodiment, referring to FIGS. 13 and 14, the results may be presented as one or more bar charts and tabulated figures including a comparison to the applicable target values for the user, for a team, for a particular assessment, and/or for a collection of assessments over time. The reports may include any appropriate information, such as information for individuals, teams, and other groups including all data cuts compared to benchmarks, such as relating to any or all of the following:
By Competency
By Sub-Competency
By Role
By Title
By Industry
By New Competencies

Providing the results to various parties may allow those parties, such as the user's manager and the client administrator, to monitor the user's progress with the assessment and talent development, prepare learning plans for teams, identify skill gaps for individuals, identify skill gaps in teams, and/or analyze results in various ways (such as per organization, job role, assessment, etc.). The assessment system 100 may also automatically provide additional information derived from the results, such as input suggestions, development plans, learning recommendations, learning roadmaps for individuals, teams, and organizations, and corresponding presentations for presenting the information to the client. In various embodiments, the report may include recommendations for training to address needs indicated by the results for personnel, teams, and/or other groups.

In various embodiments, the reports may facilitate talent and organizational indexing of capabilities, such as to allow organizations to understand where they have strengths to leverage or gaps to fill. For example, the assessment system 100 may report an inventory of individual skills and organization skills. The report may also provide recommendations to achieve goals based on the results and the target values, such as development plans, promotion strategies, hiring recommendations, skills development, and organizational development.

The additional information may be provided to any appropriate personnel, including the user, managers, administrators, and leaders. All of the results and information derived from the results may be stored in the database 112, such as to create an updated real-time database and repository for talent information.

The server 110 may generate output reports automatically or in response to requests and parameters provided by, for example, the system administrator or the client administrator. Different reports may be generated for different parties, including the overall company, leaders, managers, and individuals. Specific sets or cuts of data may be reported, such as for historical purposes, and may be associated with the relevant accounts.

The assessment system 100 may perform and store organizational assessments, which can be associated with individual competency assessment data and results at a company level. Organizational assessments may include a gauge on maturity across multiple areas of expertise. For example, organizations may dive deeper into their collective maturity and expertise in data and analytics, sustainability, strategic sourcing, and supplier relationship management in the supply management field. Each area may have complementary individual and/or organization assessments in future phases.

Access to various output features may be activated or deactivated, such as by the system administrator, for example based on purchases, subscriptions, and/or licenses. In various embodiments, the reports may be provided in multiple formats to provide a clear analysis and summary of the results. Reporting may be automated and provided in a visual format to indicate the results and gaps to noted target values, including benchmarks.

In the present embodiment, the server 110 may automate and create a roadmap for individual development and recommendations for development plans. Leaders and companies may have the ability to rank and add the level of importance of a competency based on current and future state, as well as to see gaps and an automated organizational roadmap. Companies may identify employee resources that may be underutilized opportunities based on skills and competencies, such as in conjunction with the machine learning component of the system and leveraging the data input into accounts.

The server 110 may also compare the core competencies of a participant entity to new, future, and emerging competencies, such as to assess a company and team for future transformation and preparedness. The assessment system 100 may also provide an opportunity for participant entities to indicate the organizational, team, or individual goals, and compare results to the noted priorities of those goals. The server 110 may also compare the core competencies of a participant entity to new, future, and emerging competencies to assess a participant and/or team for future transformation and preparedness. The server 110 may also provide an opportunity for companies to indicate the organizational, team or individual goals, and compare results to the noted priorities of those goals.

In various embodiments, the server 110, such as in conjunction with machine learning, may automate and create a bank of smart future job descriptions, and may automatically associate particular job descriptions with one or more job roles. The server 110 may also provide tools for succession planning, such as based on company workforces and skills, such as by developing a succession plan and providing a risk assessment based on team competencies to future needs. The database 112 may store data associated with employees of the client company, so that when the company creates a new job with noted requirements, the server 110 may assess the current team's competencies and skillset.

The process of setting up assessments for various competencies may be repeated as personnel receive training and develop their skills. By repeatedly performing assessments of personnel over time, the server 110 may track the development and improvement of users, teams, and companies over time and identify deficiencies, remedies, and improvements to develop talent in the organization. The users, managers, leaders, and other personnel may update the job roles, talents, competencies, assessment types, learning recommendations, learning plans, assessment plans, roadmaps, benchmarks, and target values over time, and monitor the progress of personnel, teams, and the overall organization.

The server 110 may automatically recommend learning programs, development paths, organizational initiatives, and/or potential operating models to achieve organizational goals, for example based on organizational goals, practice areas for the organization, and individual assessments. For example, a participating entity may provide goals and/or target values, and the server 110 may generate recommendations for achieving them. For example, a range of results applicable to a specific asset, such as an employee, team, or organization, may be provided. When a participating entity's results are within the specified range, the server 110 may display recommended actions, such as learning programs, development paths, organizational initiatives, and/or potential operating models, specific for that individual or organization. In one embodiment, users who attain a proficient result in a given competency may see recommendations for courseware that is designed to move the skill level from proficient to advanced for that competency. Users achieving advanced level results is a given number of competencies my receive a recommendation to pursue higher performance levels and/or certifications. The machine learning system 318 may also identify trends and patterns and recommend effective learning programs accordingly.

The results and other data may be collected and stored in the database 112 as an overall collection over many organizations. By collecting and storing data for personnel over multiple personnel, teams, divisions, companies and/or industries, the assessment system 100 may create a source of valuable talent and skills-based data that may accumulate. The assessment system 100 may build a pool of organization, industry, profession, and team data, which may be used for various applications, such as benchmarking, prevalence, and profession data capabilities, including predictive and prescriptive analytics based on combined platform data. For example, the system administrator may have access to and utilize the collected data. In addition, the machine learning system 318 may generate information, such as benchmarking data and trends, based on the collected data, and may provide predictive and prescriptive analytics for a profession, industry, organization, job role, title, etc.

Historical data may be sorted, analyzed for trends and changes over time, sliced, and otherwise leveraged for benchmarking and prevalence data across multiple assessments, such as across individual assessments, organizational assessments, assessments of professions, assessments of industries, and assessments of practice areas. Reporting at such levels can provide deeper content to enhance and inform other related product areas (education, certification, research, etc.). For example, the historical database may indicate trends in and/or provide aggregate views of key functional business areas, such as within an industry of even the global economy, and indicate change, health, and transformations companies are making as roles/competencies evolve within the area. Analyzing the data in the database may identify trends and changes in professions and job roles as they evolve based on the needs of the organization and demands of the global business environment. In various embodiments, the server 110 may utilize data slicing tools to filter and sort data in the database 112.

The assessment system 100 may facilitate talent assessment for an industry or area of practice for existing employees, along with new hire matching. The database 112 may include data generated by the assessment system 100 and provide the tools for sorting and reviewing it. The server 110 and database 112 may provide a database of professionals and the ability to match them with a job recommendation for an employer or for contingent workers. The database 112 may include a community of practitioners by profession and industry, with the unique data of their actual skills based on independent assessments, as opposed to the person self-selecting. By collecting the assessment data from multiple assessments over time, the database 112 may accumulate data for various professions, industries, competencies, roles, job descriptions, and assessments in one database or a limited set of databases and provide tools to leverage that data and report on it.

In various embodiments, the database 112 stores information on participant entities and individuals that have taken assessments to generate a significant pool of data for individuals. The data may be searched for hires that fit an open role within an organization. Organizations can indicate that they are looking to hire in a particular role, and the server 110 can search the database 112 using known characteristics and capabilities associated with the indicated role (including job title and description), and identify a pool of individuals to recommend or match. The pool of individuals may selected from within an organization to identify existing company talent and/or selected from a set of outside individuals having information stored in the database 112. The assessment system 100 may produce a candidate list for any open position, regardless of whether or not the candidate is associated with a company in the database 112, and make recommendations of likely candidates for open positions based upon level of skill required when compared to participant entity results.

For example, the database 112 may facilitate automatically creating job descriptions for current and/or new positions. The data in the database 112 can reflect certain competencies and subcompetencies that are important for a particular job role within an organization or an industry. By analyzing the database for the relevant competencies and subcompetencies, the assessment system 100 can automatically generate a job description of skills for any job role or combination of job roles in the database 112.

In various embodiments, historical data may be leveraged for benchmarking and prevalence data across individual and organizational assessments, as well as surveys or assessments of practice areas. The historical data may be provided to different parties having different levels of access. The present embodiment, for example, may provide three levels of access to historical data:

Level I: The participant entity subscribes to access to assessment platform and benchmarking data:

Exemplary features:
Access to additional assessments
Unlimited access to data and all its cuts
Set number of hours of advisory time to discuss data and any results
Input to drive other data/cuts
Access to meeting with leaders of other participating organizations at roundtable events
Access to job description database (which may be anonymized, and may include future job descriptions based on the assessment system machine learning)

Level II: The participant entity subscribes to annual access to unlimited benchmarking data:
Features: Unlimited access to data and all its cuts

Level III: The participant entity subscribes to annual access to limited benchmarking data:
Features: Access to set number of data cuts

Other levels of access may include ad hoc access, such as to purchase set cuts of data as needed.

Access to the historical database may also include tools to generate reports and analyses. For example, participating entities can compare their own data to past data, industry data, and/or other benchmarks and prevalence data according to any suitable criteria, such as:

By Competency

By Sub-Competency

By Role

By Title

By Industry

By New Competencies

The assessment system may also offer access to an online community, such as for personnel of a participant entity, limited to those having access to the historical database, advisors, account holders, and/or unrestricted viewing and/or participation.

The assessment system 100 may also generate reports to be used for hiring for any profession, such as by human resources personnel, talent recruiters, and learning and development leaders. For example, a participant entity may complete initial sets of assessments to establish the current state of the participant entity's talent. The server 110 may generate reports, for example in conjunction with accumulated or otherwise acquired benchmarking data and machine learning, to present job roles that align with the participant entity's needs and are recommended based on assessed skills and competencies. In addition, the server 110 may identify internal and/or external candidates that have the appropriate talents to fill such job roles for the participant entity.

The assessment system 100 may create job descriptions and facilitate succession planning based on participant entity workforces and skills. The assessment system 100 may facilitate building out a succession plan and provide a risk assessment based on team competencies to future needs. The assessment system 100 may include database functionality to store employees with the associated participant entity, so that when the participant entity creates a new job with noted requirements, the assessment system 100 may assess the current team's competencies and skillset. This may be useful for ongoing engagement and for users to keep profiles current, particularly with reassessments.

In various embodiments, the hiring managers may provide a job description for an open position to the assessment system 100. For example, the server 110 may prompt the hiring manager to provide relevant information with a series of questions relating to the position, such as questions to assess skills and/or competencies to include in assessing candidates. Using the information provided, the server 110 and/or machine learning system 318 may assign a job role to the position and/or provide candidate job roles to the hiring manager for review and selection.

The server 110 and/or machine learning system 318 may review the database of personnel for potential and/or best matches for the open position based on the identified job role and/or skills and competencies. For example, the machine learning system 318 may identify one or more job roles that align with the job description and assessed skills and competencies.

Other candidates may also be requested to take assessments to assess their skills and/or competencies for the position. For example, a new potential hire may create an account, log in, and take one or more relevant assessments for the position.

The server 110 and/or machine learning system 318 may analyze the various candidates for a best match to the requirements of the position, as well as any noted development needs, reservations, or limitations. A summary and detailed report may be provided for the hiring manager on one or more candidates' results and the level of the candidate's match to the open position. The candidate may also receive a summary snapshot of their results.

The assessment system 100 may be implemented in any appropriate manner to assess the talents, skills, or other characteristics of the participating entities. For example, a method for assessing talent of a remote user associated with an organization according to various aspects of the present technology may comprise providing a talent assessment to the remote user via the internet; storing results of the talent assessment in a database; automatically comparing the results to target values for the organization and/or the user; and automatically recommending an action for the organization and/or the user according to differences between the results and the target values.

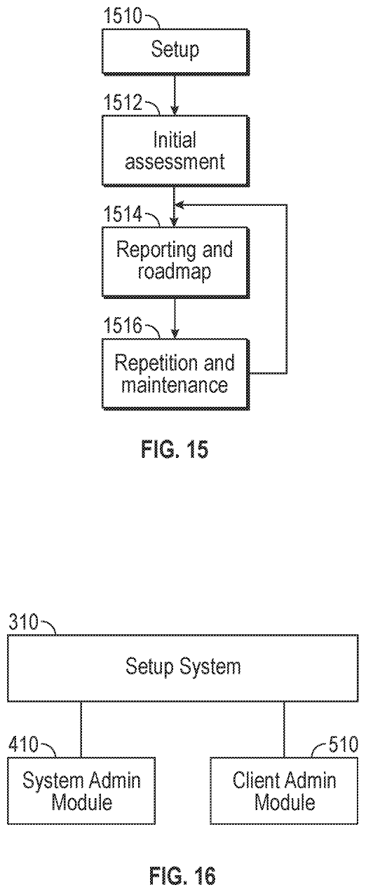

For example, referring to FIG. 15, a method for the assessment system 100 may comprise setting up the assessment system 100 to perform one or more assessments 1510; performing an initial assessment 1512; reporting the results of the assessment and preparing a roadmap for advancement 1514; and repeating assessments and maintaining improvement 1516. The various elements and steps of the method may be implemented according to the environment and application of the assessment system. The assessment system 100 may utilize automated steps and processes through the server 110.

Setting up the assessment system 100 to perform one or more assessments 1510 may comprise any appropriate steps and elements to ready the assessment system 100 for assessing one or more people, such as in conjunction with the setup system 310, the system administrator module 410, and the client administrator module 510. For example, referring to FIG. 16, the assessment system 100 may initiate the setup system 310, and may use information and actions received via the system administrator module 410 and the client administrator module 510.

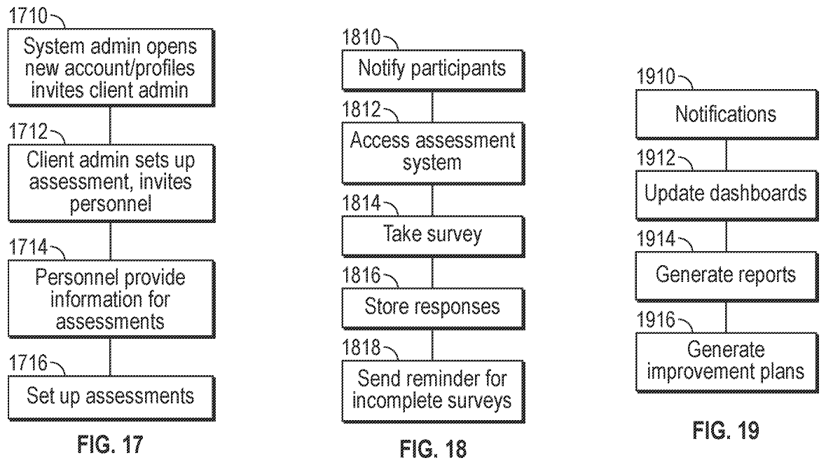

In various embodiments, referring to FIG. 17, the setup system 310 is initiated by the system administrator, who opens a new account and profile for a new participant entity 1710. The system administrator may provide any suitable information, such as an identifier for the participant entity and email address for a client administrator associated with the participant entity. The system administrator may also set up reporting functions and progress meetings with the participant entity, such as using default functions and/or templates in the setup system 310. The setup system 310 may automatically send an invitation email to the client administrator with a link to access the setup system 310.

Upon accessing the setup system 310, the client administrator may be prompted, for example via the client administrator module 510, to provide various information to set up assessments for the participant entity, such as account and profile information for the client administrator (e.g., name, title, contact information, and password) 1712. The client administrator may provide information for the participant entity, such as size, structure, locations, and industry type. The client administrator may also provide information to support the assessments, such as a schedule, timeline, and reminders for the assessment, and identify the relevant job roles, for example by providing job descriptions and/or titles for various personnel to be assessed and/or selecting from a list of candidate job roles. The client administrator may also provide target values for the assessments' competencies, or may select default values, such as values based on benchmarks. The client administrator may further provide the names and email or other contact information for managers and employees to participate in assessments, such as by uploading or manually entering the information.

The information provided by the client administrator may reflect a talent development plan designed to assess the needs of the participant entity, determine the current state of the participant entity's personnel, and develop the talent of the personnel to meet the needs. In the present embodiment, the client administrator module 510 identifies assessment system 100 features so the client administrator may select those features that best fit the participant entity's needs.

The setup system 310 may automatically send invitation emails to the managers and employees identified by the client administrator with links to access the setup system 310. Upon accessing the setup system 310, the managers and employees may be prompted, for example via the client manager module 910 and the client employee module 1112, to provide various information to set up assessments, such as account and profile information for the client (e.g., name, title, contact information, and password) 1714. The managers may provide and/or confirm information for their teams, such as names, contact information, positions, job roles (current and/or anticipated), and/or experiences levels. The managers and employees may also provide information to support the assessments, such as identifying personal needs and wishes for skill development and identifying and/or confirming the relevant job roles, for example by providing job descriptions and/or titles for the managers and employees and/or selecting from a list of candidate job roles.

The setup system 310 may automatically set up the assessments according to the information received 1716. For example, the setup system 310 may identify surveys for the various personnel and set target values, such as according to values provided by the client administrator, job roles, and/or any other appropriate criteria. In various embodiments, the job roles for a single user may vary for different assessments. For example, an individual may be assigned the role of Senior Buyer for a Supply Chain Assessment, while the same individual may be classified as a member of leadership for a soft skills assessment. The setup system 310 may also automatically map the relevant competencies and descriptions of the participant personnel to job roles based on the assessment type, which can be reviewed and adjusted by the client administrator. The setup system 310 may also automatically set dates, times, and deadlines for completing surveys and providing reminders to complete surveys.

When the setup system 310 has set up the assessments, they may be reviewed, approved, and/or adjusted, such as by the system administrator and/or the client administrator. The assessment module 312 then implements the assessments by providing the appropriate surveys to the proper personnel and receiving and storing the survey responses.

For example, referring to FIG. 18, the assessment module 312 may initiate an assessment and automatically notify participants in the assessment, such as by sending an email to each participant with a unique link to begin taking the assigned survey(s) 1810. Upon accessing the link, the participant may begin participating in the assessment 1812. For example, the link may bring up the client employee dashboard 1113, which may allow the user to select a survey and begin taking it 1814. The assessment module 312 may receive and store the user's responses 1816. When the survey is complete, assessment module 312 may indicate that the survey is complete, such as on the employee's dashboard, the relevant team manager's dashboard, the client administrator dashboard, and/or the system administrator dashboard. If the survey is not completed or started, the assessment module 312 may provide reminders to the participants of the deadline to complete the survey 1818. Personnel with authorization, such as the client administrator and system administrator, may monitor the progress of the assessment, such as through the appropriate dashboard.

When an assessment is complete, the reporting system 314 may provide the results to authorized personnel. For example, referring to FIG. 19, the reporting system 314 may provide notifications to authorized personnel that the assessment is complete, and the results may be reviewed (1910). The dashboards of the relevant personnel may be updated accordingly with links to view the results and information derived from the results (1912). The reporting system 314 may automatically generate different reports for different personnel, such as user reports for individual users, team reports for team managers, and organizational reports for participant entity leaders (1914). The reporting system 314 may also provide custom reports in response to requests from authorized personnel, such as assessments results per organization or organizational unit, per department, per team or group, per job role, and/or per assessment. The reports and related information may be stored in the database 112.

The reporting system 314 and personnel may also generate projections and improvement plans based on the assessment results (1916). For example, the reports may identify skill gaps among personnel and organizational units, such as areas where the personnel's skills are below the benchmarks or other target values. The reporting system 314 may automatically highlight the skill gaps and automatically propose remedies, such as additional training or hiring. In various embodiments, the reporting system 314 may utilize roadmap templates for reporting skill gaps and providing a roadmap or other plan for addressing the skill gaps. The resulting roadmap may be used to generate action, such as providing a basis for presentation to organizational leadership for improvement, such as via learning recommendations. In addition, the reporting system 314 may create different report for different personnel, such as users, team managers, administrators, and leaders. The reporting system 314 may also use the results to automatically generate follow-up assessments, such as to evaluate the effects of improvement plans over time.

The maintenance system 316 may access the results and improvement plans to formulate additional assessments, reports, and improvement plans. For example, the initial assessment of a participant entity may focus on the current skills and talents of personnel in the participant entity relative to the target values. The maintenance system 316 may generate assessments to assess the improvements of personnel over time, suitability of personnel for higher or other positions, or identifying organizational needs. Thus, the maintenance system 316 may receive information regarding various personnel, teams, departments, and the like, and their objectives. The maintenance system 316 may then prepare assessments, such as automatically and/or with manual oversight, based on the needs of the participant entity. The assessment module 312 and reporting system 314 may then implement and report the assessments. Users, managers, and leaders may review the results, such as to identify changes in skills and review and update assessment and improvement plans. The maintenance system 316 may repeat the process to continuously evaluate the progress of the participant entity and identify needs and possibilities for improvement.

Methods and systems for assessing talent according to various aspects of the present system may facilitate benchmarking and gathering prevalence data over time. The assessment system 100 may collect data in a single database, such as an updated real-time repository, to provide insights about the standard and potential levels of skill and talent across multiple personnel, departments, and organizations. The data may also be analyzed to highlight role, title, competency and sub-competency trends, such as by profession or industry, and identify new competencies, titles, and roles as they emerge.

Participant entities may use the assessment system for evaluation, training, development, promotion, and hiring. For example, the reports may facilitate assessments, reassessment and data comparisons, including company and individual development and movement. The assessments results may identify underutilized internal resources, such as personnel having skills suited to positions of need within an organization. Further, by identifying skill gaps, the assessment system 100 informs training decisions for participant entities and can evaluate the impact of new team members in reassessment comparison. The assessment system 100 can rank skills for a team, assist in developing career paths, and provide development plans and roadmaps for individuals, job positions, and organizations. The assessment system 100 can also improve hiring, such as by identifying important skills and talents for positions, determining skills, talents, and positions missing or lacking in a participating entity, create and inform future job descriptions, and evaluating candidates.

In the foregoing specification, the invention has been described with reference to specific exemplary embodiments. Various modifications and changes may be made, however, without departing from the scope of the present invention. The specification and figures are illustrative, not restrictive, and modifications are intended to be included within the scope of the present invention. Accordingly, the scope of the invention should be determined by any resulting claims and their legal equivalents rather than by merely the examples described.

For example, the steps recited in any method or process may be executed in any order and are not limited to the specific order presented. Additionally, the components and/or elements recited for any apparatus may be assembled or otherwise operationally configured in a variety of permutations and are accordingly not limited to the specific configuration described.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise,” “comprises,” “comprising,” “having,” “including,” “includes,” or any variations of such terms, are intended to reference a non-exclusive inclusion, such that a process, method, article, composition, or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

1. A talent assessment system accessible to multiple remote users associated with an organization, comprising:
a database; and
a server, wherein the database is responsive to the server, and wherein:
the server provides a talent assessment to the remote users;
the server stores results of the talent assessment in the database;
the server compares the results to target values for the organization; and
the server recommends an action to improve the organization according to differences between the results and the target values.

2. A talent assessment system according to claim 1, wherein the server selects the target values according to a maturity model for the organization.

3. A talent assessment system according to claim 1, wherein the server selects the target values according to an industry benchmark for the organization.

4. A talent assessment system according to claim 1, wherein the server automatically assigns a job role to the remote user according to a least one of a job title and a job description of the remote user.

5. A talent assessment system according to claim 1, further comprising a machine learning system in communication with the database, wherein the machine learning system generates benchmarks based on the results.

6. A talent assessment system according to claim 1, further comprising a machine learning system in communication with the database, wherein the machine learning system automatically associates a job role with a job title according to data associated with multiple remote users stored in the database.

7. A talent assessment system according to claim 1, wherein the server provides a client administrator interface, wherein the client administrator interface facilitates selection of the target values for the organization.

8. A talent assessment system according to claim 1, wherein the server recommends a training program for the remote user according to differences between the results and the target values.

9. A talent assessment system according to claim 1, wherein the talent assessment assesses soft skills of the remote users.

10. A talent assessment system according to claim 1, wherein the server generates reports for multiple remote users associated with a team in an organization.

11. A talent assessment system according to claim 1, wherein the server generates reports regarding a development of the organization based on the results of multiple assessments taken by the remote users.

12. A talent assessment system according to claim 1, wherein the server is accessible to multiple organizations.

13. A talent assessment system accessible by a remote organization representative and multiple remote users associated with an organization, comprising:
a proprietary database; and
a server, wherein the proprietary database is responsive to the server, and wherein:
the server provides a client administrator interface to the remote organization representative, wherein the client administrator interface requests information relating to the multiple remote users;
the server facilitates assigning a job role to each of the multiple remote users;
the server facilitates selecting an assessment for each of the multiple remote users according to the assigned job role;
the server provides the assessment to each of the multiple remote users;
the server stores the results of the assessments;
the server facilitates selecting target values for the organization;
the server compares the results of the assessments of the multiple remote users to the target values;
the server provides a report to the remote organization relating to the comparison of the results to the target values selected for the organization; and
the server provides an action recommendation for the organization based on the comparison of the results to the target values.

14. A talent assessment system according to claim 13, wherein the server facilitates assigning the target values according to a maturity model for the organization.

15. A talent assessment system according to claim 13, wherein the server facilitates assigning the target values according to an industry benchmark for the organization.

16. A talent assessment system according to claim 13, wherein the server facilitates assigning the job role to each of the multiple remote users by automatically assigning the job role to each of the multiple remote users according to the multiple remote users' job titles.

17. A talent assessment system according to claim 13, wherein the server the server facilitates selecting the assessment for each of the multiple remote users by automatically assigning the assessment to each of the multiple remote users according to the multiple remote users' job roles.

18. A talent assessment system according to claim 13, wherein the server facilitates selecting target values for each for the multiple remote users by automatically selecting the target values for each of the multiple remote users according to the multiple remote users' job roles.

19. A talent assessment system according to claim 13, further comprising a machine learning system in communication with the database, wherein the machine learning system generates professional benchmarks for the organization based on the results for the multiple remote users.

20. A talent assessment system according to claim 13, further comprising a machine learning system in communication with the database, wherein the machine learning system automatically associates a job role with a job title according to data associated with the multiple remote users stored in the database.

21. A talent assessment system according to claim 13, wherein the server recommends a training program for at least one of the remote users according to differences between the results and the target values.

22. A method for assessing talent of a remote user associated with an organization, comprising:
providing a talent assessment to the remote user via the internet;
storing results of the talent assessment in a database;
automatically comparing the results to target values for the organization; and
automatically recommending an action for the organization according to differences between the results and the target values.
